(19) United States
(12) Patent Application Publication
(10) Pub. No.: US 2007/0227034 A1
(43) Pub. Date: Oct. 4, 2007

(54) Method and apparatus for drying coated film, and method for manufacturing optical film

(75) Inventors: Tomonari Ogawa, Fujinomiya-shi (JP); Kazuhiko Nojo, Fujinomiya-shi (JP); Hideaki Kominami, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/729,887

(22) Filed: Mar. 30, 2007

(30) Foreign Application Priority Data
Mar. 30, 2006 (JP) 2006-095812

(51) Int. Cl. F26B 3/00

(52) U.S. Cl. 34/444; 34/487; 34/488; 34/463

(57) ABSTRACT

A coated film drying method for drying a film which is coated on a surface of a web while the web is running through a tunnel-shaped dry case having a web entrance and a web exit, comprising the steps of:
blowing dry air toward a surface of the coated film through an outlet port which is provided with a porous distributor; and
sucking the dry air through an inlet port which is disposed at a position downstream or upstream of the position where the dry air is blown out and on the same side as that on which the outlet port is disposed relative to the coated film, so that a stream of the dry air which flows in a direction parallel to the running direction of the web is formed across the entire width of the surface of the coated film.

### BACKGROUND OF THE INVENTION

1. Field of the Invention

The present invention relates to method and apparatus for drying a coated film and a method for manufacturing an optical film, in particular, relates to a method and apparatus for drying a coated film and a method for manufacturing an optical film which can be preferably applied to a manufacturing of an optical film such as an optical compensation film, an anti-reflection film, and anti-glare film, and an optical film which is useful in improving unevenness of a liquid crystal layer.

2. Description of the Related Art

Recently, the demand for optical films has been increased. The optical films have various functions, and include, for example, an optical compensation film which is used as a phase difference board in a liquid crystal cell, an anti-reflection film, and an anti-glare film.

Representative examples of the method for manufacturing such an optical film includes the one for forming a coating film which has functionality of various compositions by applying a coating solution to a surface of a web which is a strip-shaped flexible support medium by using various coating apparatuses and drying the web. Conventionally, various suggestions have been made for a method or apparatus for forming and drying a coated film (for example, see Japanese Patent Application Laid-Open Nos. 9-73081, 2000-157923, 2003-126108, and 2003-93954).

In the field of manufacturing such an optical film, the drying of a coated film, in particular just after a coating, is critical. Since an optical film requires a coated film having a uniform thickness, it is important to eliminate any drying unevenness of an optical film which is extremely sensitive to a deviation in drying rate.

However, conventionally, as disclosed in the above Japanese Patent Application Laid-Open No. 9-73081, when a coating is performed at a room temperature, the air flow there has not been particularly regulated. That is, some devices, such as a case to cover a part of a web to be dried, are simply used to prevent disturbance. Alternatively, as disclosed in the above Japanese Patent Application Laid-Open Nos. 2000-157923 and 2003-126108, only a wind velocity has been regulated without providing such a case to prevent disturbance, both of which were insufficient to achieve an uniform drying just after a coating.

To the contrary, as disclosed in the above Japanese Patent Application Laid-Open No. 2003-93954, another suggestion has been made in which a porous distributor having a plurality of holes is disposed close to a surface of a film right after the position of a coating so that a dry evaporated gas is exhausted at a constant rate to suppress drying unevenness, which is highly effective for a drying right after a coating. Furthermore, a Japanese Examined Application Publication No. 2-58554 discloses a porous barrier (porous distributor) which is disposed close to a surface of a coated film so as to blow dry air through the porous barrier to the coated film surface, resulting in dry air which is uniformly blown.

Although the porous distributor allows dry air to be uniformly blown to a coated film surface therethrough, because the dry air only passes through the distributor, after hitting the coated film surface, the blown dry air flows in radial directions over the coated film surface. This forms streams of the dry air in a width direction of a web, and forward and backward running directions of the web.

When the radial streams of dry air are considered from viewpoint of a drying of a coated film in a width direction of a web, more volume of the air flows along the both ends of the web than along the central part of the web, and this causes drying unevenness between the central part of the web and the ends of the web. Particularly, a higher wind speed of the blown air increases the volume of the air along the both ends of the web, and this tends to cause drying unevenness.

Meanwhile, when the radial streams of dry air are considered from viewpoint of a drying of a coated film in forward and backward running directions of a web, if the inside of a drying apparatus is separated into a plurality of drying zones along the running direction of the web which are under different drying conditions, the dry air masses blown out of the adjacent zones collide to each other. The collision of the dry air masses causes an unrectified flow of dry air on the coated film surface, which in turn causes drying unevenness. The dry air masses collide not only in the case where a plurality of drying zones are provided but also in the case where a plurality of blowers individually having a porous distributor are arranged in a drying apparatus which include a long drying path between a web entrance and a web exit along a running direction of a web.

### SUMMARY OF THE INVENTION

The present invention was made in view of the above situation, and an object of the present invention is to provide, in the field where a highly accurate drying of an optical film and the like is required, a method and apparatus for drying a coated film which achieves a uniform drying of a coated film without causing drying unevenness on a surface of the coated film, and a method for manufacturing an optical film.

A first aspect of the present invention provides, in order to achieve the above object, a coated film drying method for drying a film which is coated on a surface of a web while the web is running through a tunnel-shaped dry case having a web entrance and a web exit, comprising the steps of: blowing dry air toward a surface of the coated film through an outlet port which is provided with a porous distributor; and sucking the dry air through an inlet port which is disposed at a position downstream or upstream of the position where the dry air is blown out and on the same side as that on which the outlet port is disposed relative to the coated film, so that a stream of the dry air which flows in a direction parallel to the running direction of the web is formed across the entire width of the surface of the coated film.

According to the first aspect, by blowing dry air toward a surface of a coated film through an outlet port which is provided with a porous distributor, a uniformly blowing of dry air can be achieved which causes the dry air to uniformly hit the entire surface of the coated film. In the present invention, in addition to the uniform blowing of dry air, since the dry air is sucked through an inlet port which is disposed at a position downstream or upstream of the position the dry air is blown out and on the same side as that on which the outlet port is disposed relative to the coated film, a stream of the dry air which flows in a direction parallel to the running direction of the web (from the outlet port to the inlet port) is formed without turbulence across the entire width of the surface of the coated film. When an inlet port is disposed downstream of an outlet port, the stream of the dry air flows in the same direction as the running direction of the web, while when an inlet port is disposed upstream of an outlet port, the stream of the dry air flows in the opposite direction to the running direction of the web.

The term “without turbulence” as used herein means that a stream of dry air flows without forming any turbulence such as eddy current.

Thus, no more volume of dry air flows along the both ends of a web in the width direction of the web than along the central part of the web, and no dry air masses collide to each other to form an unrectified flow on the surface of a coated film. Therefore, in the field where a highly accurate drying of an optical film and the like is required, a uniform drying of a coated film can be achieved without causing drying unevenness on a surface of the coated film.

In order to form a unidirectional stream of dry air which flows in a direction parallel to the running direction of a web across the entire width of a surface of a coated film, both of an outlet port and an inlet port have a length in the width direction of the web which is preferably generally equal to the web width, and is more preferably longer than the web width by 50 mm or less. An excessive length of an outlet port and an inlet port in the width direction of a web compared to the width of the web increases dry air that flows into the back side of the web, and a stream of dry air in a direction parallel to the running direction of the web cannot be easily formed.

A second aspect provides the coated film drying method according to the first aspect of the present invention, wherein the inlet port is also provided with a porous distributor.

Since the inlet port is also provided with a porous distributor as described in the second aspect, a uniform suction of dry air is achieved, resulting in that a further uniform stream of dry air can be formed.

A third aspect provides the coated film drying method according to the first or second aspect of the present invention, wherein the outlet port and the inlet port have a length of 3 cm or more in the running direction of the web, and has a length which is generally equal to the width of the web in the width direction of the web.

In the present invention, it is critical to accurately convert the dry air which is blown toward a coated film into a unidirectional stream of dry air which flows in a direction parallel to the running direction of the web. However, if dry air is blown through an outlet port, which is formed into a slit shape to be elongated in the width direction of the web, in the shape of curtain, and the dry air is sucked through an inlet port, which is also formed into a slit shape, in the shape of curtain, the dry air is not uniformly blown or sucked, and a unidirectional stream of dry air which flows in a direction parallel to the running direction of the web cannot be easily formed.

So, in the third aspect, the outlet port and the inlet port have a length which is generally equal to the width of the web, and also has a length of 3 cm or more in the web running direction. This configuration allows dry air to be uniformly blown through a porous distributor which is provided to an outlet port and to be uniformly sucked through a porous distributor which is provided to an inlet port, so that a gentle and smooth blow and suck of the dry air can be achieved, and a unidirectional stream of the dry air which flows in a direction parallel to the running direction of the web can be easily formed. There is no upper limit upon the length of the outlet port and the inlet port in the web running direction, and the length may be conveniently set depending on the length of a dry path of a drying zone and the number of the outlet ports and the inlet ports provided in the drying zone.

A fourth aspect provides the coated film drying method according to any one of the first to third aspects of the present invention, wherein the dry air is blown toward the surface of the coated film at a wind speed of 0.1 to 3 m/sec.

If dry air is blown toward a surface of a coated film at a high wind speed more than 3 m/sec, after hitting and drying the coated film surface, the dry air tends to form radial flows in spite of any suction, and a unidirectional stream of dry air which flows in a direction parallel to the running direction of the web cannot be easily formed on the coated film surface. To the contrary, if dry air is blown toward a coated film at a low wind speed less than 0.1 m/sec, the drying ability of the dry air is considerably decreased, which requires an extremely long drying path.

A fifth aspect provides the coated film drying method according to any one of the first to fourth aspects of the present invention, wherein the linear wind speed of the unidirectional stream of dry air is within a range of 0.2 to 3 m/sec for the running web.

The fifth aspect defines an appropriate speed of a unidirectional stream of dry air which is formed on a coated film surface and flows in a direction parallel to the running direction of a web, because a high linear wind speed more than 3 m/sec tends to cause turbulence in the unidirectional stream of dry air which flows in a direction parallel to the running direction of the web. Also a low linear wind speed less than 0.2 m/sec tends to develop a convection effect which is caused by a solvent (a solvent contained in a coating solution) evaporated from the coated film surface, and a unidirectional stream of dry air which flows in a direction parallel to the running direction of the web cannot be easily formed.

A sixth aspect provides the coated film drying method according to any one of the third to the fifth aspects of the present invention, wherein the porous distributor provided to the outlet port and the porous distributor provided to the inlet port are separated from the coated film surface by a distance of 50 mm or less.

If the porous distributor provided to the outlet port and the porous distributor provided to the inlet port are separated from a coated film surface by a distance more than 50 mm, a convection tends to be formed due to a solvent which is evaporated from the coated film surface, and a unidirectional stream of dry air which flows in a direction parallel to the running direction of the web cannot be easily formed. There is no particular lower limit upon the distance, but the closest distance between the porous distributors and the coated film surface without contact will be the lower limit.

A seventh aspect of the present invention provides, in order to achieve the above object, a coated film drying apparatus for drying a film which is coated on a surface of a web while the web is running through a tunnel-shaped dry case having a web entrance and a web exit, comprising: a blowing device which includes an outlet port having a length generally equal to the width of the web and blows dry air toward a the coated film surface, the outlet port being provided with a porous distributor; and a suction device which is disposed on the same side as that on which the blowing device is disposed relative to the coated film surface and includes an inlet port having a length generally equal to the width of the web for sucking the dry air blown out of the blowing device therethrough, the blowing device and the suction device being alternatively arranged along the web running direction in the dry case.

The seventh aspect defines an apparatus structure of the present invention in which no more volume of dry air flows along both ends of a web in the width direction of the web than along the central part of the web, and a collision of dry air blown out masses to each other which forms an unrectified flow on a coated film surface can be prevented. Therefore, in the field where a highly accurate drying of an optical film and the like is required, a uniform drying of a coated film can be achieved without causing drying unevenness on a surface of the coated film.

An eighth aspect provides the coated film drying apparatus according to the seventh aspect of the present invention, wherein the inlet port is also provided with a porous distributor for sucking dry air therethrough.

Since the inlet port of the suction device is also provided with a porous distributor for sucking dry air therethrough as described in the eighth aspect, a uniform suction of dry air is achieved, resulting in that a further uniform stream of dry air can be formed.

A ninth aspect provides the coated film drying apparatus according to the seventh or eighth aspect of the present invention, wherein the porous distributor is a wire mesh or a perforated metal.

The ninth aspect defines a preferable material for forming a porous distributor, and a wire mesh or a perforated metal can be preferably used.

A tenth aspect provides the coated film drying apparatus according to any one of the seventh to the ninth aspects of the present invention, wherein the outlet port and the inlet port have a length of 3 cm or more in the running direction of the web, and has a length which is equal to the width of the web in the width direction of the web.

This configuration allows dry air to be uniformly blown through a porous distributor provided to an outlet port and to be uniformly sucked through a porous distributor provided to an inlet port, so that a gentle and smooth blow and suck of the dry air can be achieved, and a unidirectional stream of the dry air which flows in a direction parallel to the running direction of the web can be easily formed.

An eleventh aspect provides the coated film drying apparatus according to any one of the seventh to the tenth aspects of the present invention, wherein the porous distributor provided to the outlet port and the porous distributor provided to the inlet port are separated from the coated film surface by a distance of 50 mm or less.

If the porous distributor provided to the outlet port and the porous distributor provided to the inlet port are separated from a coated film surface by a distance more than 50 mm, a convection tends to be formed due to a solvent which is evaporated from the coated film surface, and a unidirectional stream of dry air which flows in a direction parallel to the running direction of the web cannot be easily formed.

A twelfth aspect provides the coated film drying apparatus according to any one of the seventh to the eleventh aspects of the present invention, wherein a plurality of blowing and suction units each of which includes the blowing device and the suction device are arranged along the direction from the web entrance to the web exit in the dry case in correspondence to the length between the web entrance and the web exit.

According to the twelfth aspect, a unidirectional stream of dry air which flows in a direction parallel to the running direction of the web can be accurately formed, and also the blowing device and the suction device are combined as a unit, so that a plurality of the units required for length from the web entrance to the web exit in the dry case are arranged along the direction from the web entrance to the web exit. This configuration allows a unidirectional stream of dry air which flows in a direction parallel to the running direction of the web to be easily formed, regardless of the length of a dry path in a dry case.

A thirteenth aspect provides the coated film drying apparatus according to any one of the seventh to the twelfth aspects of the present invention, wherein a planar member having a planar surface which is flush with the outlet port and the inlet port is interposed between the blowing device and the suction device.

According to the thirteenth aspect, as a preferable mode of a blowing and suction unit, a planar member having a planar surface which is flush with the outlet port and the inlet port is interposed between the blowing device and the suction device, so that a narrow flow path for guiding dry air from the outlet port to the inlet port is formed between the planar member and the coated film surface. This makes it easier to form a unidirectional stream of dry air which flows in a direction parallel to the running direction of the web, and also makes it difficult to form turbulence such as eddy current in the stream of dry air.

A fourteenth aspect provides the coated film drying apparatus according to the thirteenth aspect of the present invention, wherein the planar member has a length of 5 cm or more in the running direction of the web.

The fourteenth aspect defines a length of the planar member in the running direction of the web because a length less than 5 cm has less effect in guiding dry air. There is no particular upper limit upon the length of the planar member in the web running direction, and the length may be conveniently set depending on the length of a dry path of a drying zone, and the number of the outlet ports, the inlet ports, and the planar members provided in the drying zone.

A fifteenth aspect provides the coated film drying apparatus according to any one of the seventh to the fourteenth aspects of the present invention, wherein the dry air is blown out of the blowing device toward the coated film surface at a wind speed of 0.1 to 3 m/sec.

If dry air is blown toward a coated film surface at a high wind speed more than 3 m/sec, after hitting and drying the coated film surface, the dry air tends to form a radial flow in spite of any suction downstream, which decreases the effect of the present invention. To the contrary, if dry air is blown toward a coated film surface at a low wind speed less than 0.1 rn/sec, the drying ability of the dry air is considerably decreased, which requires an extremely long drying path.

A sixteenth aspect provides the coated film drying apparatus according to any one of the seventh to the fifteenth aspects of the present invention, wherein the dry air blown through the outlet port is sucked through the inlet port so that a unidirectional stream of the dry air which flows in a direction parallel to the running direction of the web is formed on the coated film surface, and the linear wind speed of the unidirectional stream is within a range of 0.2 to 3 m/sec.

The sixteenth aspect defines an appropriate speed of a unidirectional stream of dry air which is formed on a coated film surface and flows in a direction parallel to the running direction of the web, because a high linear wind speed more than 3 n/sec tends to cause turbulence in the unidirectional stream of dry air which flows in a direction parallel to the running direction of the web. Also a low linear wind speed less than 0.2 n/sec tends to develop a convection effect which is caused by a solvent (a solvent contained in a coating solution) evaporated from the coated film surface, and a unidirectional stream of dry air which flows in a direction parallel to the running direction of the web cannot be easily formed.

A seventeenth aspect provides the coated film drying apparatus according to any one of the seventh to the sixteenth aspects of the present invention, wherein the outlet port has a length in the width direction of the web which is longer than the web width by 50 mm or less.

The seventeenth aspect defines a length of the outlet port because an excessive length of an outlet port in the width direction of a web compared to the width of the web increases dry air that flows into the back side of the web, and a stream of dry air parallel to the running direction of the web cannot be easily formed.

An eighteenth aspect provides the coated film drying apparatus according to any one of the twelfth to the seventeenth aspects of the present invention, wherein the blowing and suction unit is arranged at least until the point of time when the concentration value of a solvent contained in the coated film decreases to 50% or less of the value of the solvent at the application of the coating, or the viscosity of the coated film increases to 10 mPa·s or more, whichever comes first.

When the coated film still contains a solvent at a high percentage or when the viscosity of the coated film is still low and the coated film is likely to flow at an early stage of drying, because an appropriate drying of the coated film is critical in manufacturing a coated film product, particularly an optical film, the drying method according to the present invention is especially effective.

A nineteenth aspect provides the coated film drying apparatus according to any one of the twelfth to the eighteenth aspects of the present invention, wherein the blowing and suction unit is arranged downstream of the position where the film is coated onto the web, at least by 10 cm.

The blowing and suction unit blows dry air out of a blowing device and sucks the dry air into a suction device to form a stream of the dry air which flows in a direction parallel to the running direction of the web over a coated film surface, and there is almost no dry air which flows through a web entrance of a dry case toward the coated film. However, since even a tiny stream of air adversely affects a coating when a film is being coated at a coating section as in the nineteenth aspect, the blowing and suction unit is preferably arranged downstream of the coating position of a coating section at least by 10 cm. A closer arrangement of the blowing and suction unit may cause disturbance in drying a coated film surface.

A twentieth aspect provides, in order to achieve the above object, a method for manufacturing an optical film, comprising the step of using the drying apparatus any one of according to the seventh to the nineteenth aspects of the present invention in a manufacturing line for an optical film.

A twenty-first aspect provides the method for manufacturing an optical film according to the twentieth aspect of the present invention, wherein the optical film is an optical compensation film, an anti-glare film, or an anti-reflection film.

The twentieth and twenty-first aspects of the present invention provide a method for manufacturing an optical film which uses a drying apparatus according to the present invention, and in the method, the use of a drying apparatus according to the present invention enables a manufacture of the optical film which has an excellent surface without drying unevenness.

As described above, according to the present invention, in the field where a highly accurate drying of an optical film and the like is required, a uniform drying of a coated film can be achieved without causing drying unevenness on a surface of the coated film.

### BRIEF DESCRIPTION OF THE DRAWINGS

FIG. 1 is a cross sectional view showing an aspect of a drying apparatus according to the present invention having a dry case which is divided into three parts;

FIGS. 2A and 2B are conceptual views showing a drying apparatus according to the present invention which is configured with a blowing device, a planar member, and a suction device;

FIG. 3 is a cross sectional view showing a blowing device of a drying apparatus according to the present invention;

FIG. 4 is a cross sectional view showing a suction device of a drying apparatus according to the present invention;

FIGS. 5A and 5B are conceptual views showing a drying apparatus according to the present invention which is configured with a blowing device and a suction device;

FIG. 6 is a view illustrating a line for manufacturing an optical compensation film in which an apparatus for drying a coating solution according to the present invention is incorporated;

FIG. 7 is a view illustrating a line for manufacturing an anti-glare film and an anti-reflection film in which an apparatus for drying a coating solution according to the present invention is incorporated;

FIG. 8 is a table summarizing the results of Example A;

FIG. 9 is a table summarizing the results of Example B;

FIG. 10 is a table summarizing the results of Example C;

FIG. 11 is a table summarizing the results of Example D; and

FIG. 12 is a table summarizing the results of Example E.

### DETAILED DESCRIPTION OF THE PREFERRED EMBODIMENTS

Now, with reference to the accompanying the drawings, preferable embodiments of a method and apparatus for drying a coating solution according to the present invention will be explained in detail below.

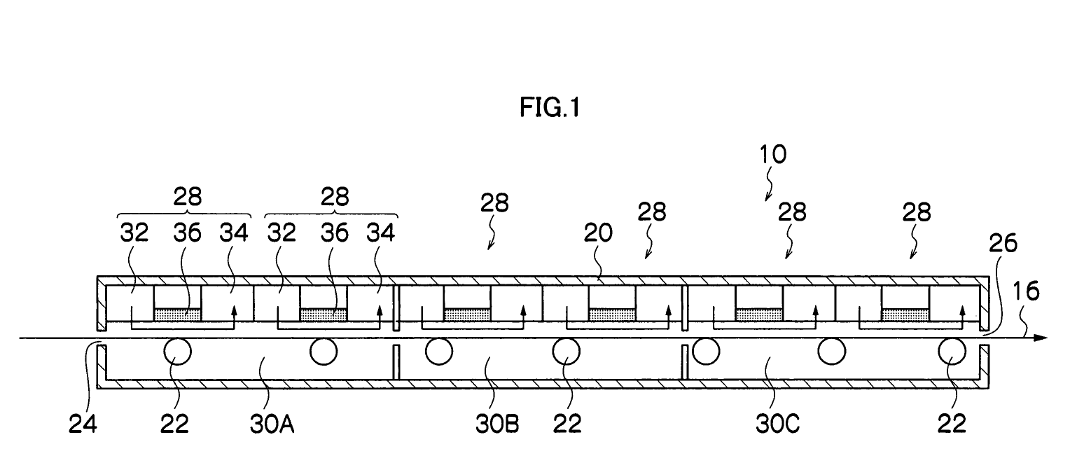

A drying apparatus 10 according to the present invention can be preferably used as an apparatus for drying a coated film in a manufacturing line for an optical film such as an optical compensation film, an anti-glare film, and an anti-reflection film which is used in a liquid crystal display (LCD), and is particularly effective at an early stage of drying. Now, a drying apparatus according to the present invention will be explained, and also a manufacturing line for an optical compensation film in which the present invention is incorporated, and a manufacturing line for anti-glare film and anti-reflection film will be explained below. First, with reference to FIG. 1 to FIG. 4, a drying apparatus 10 according to the present invention will be explained.

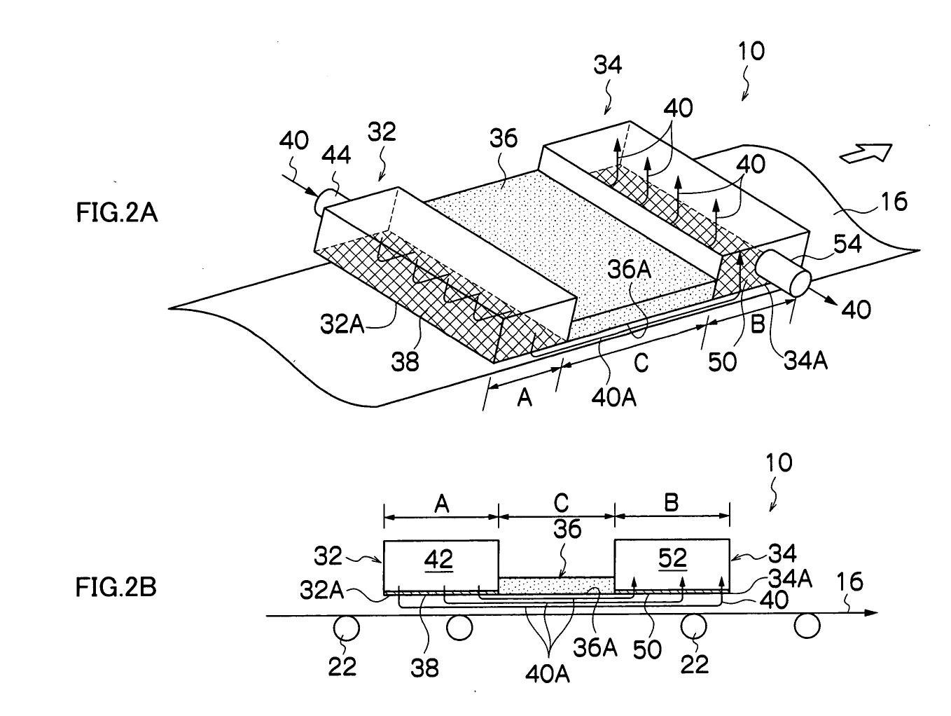

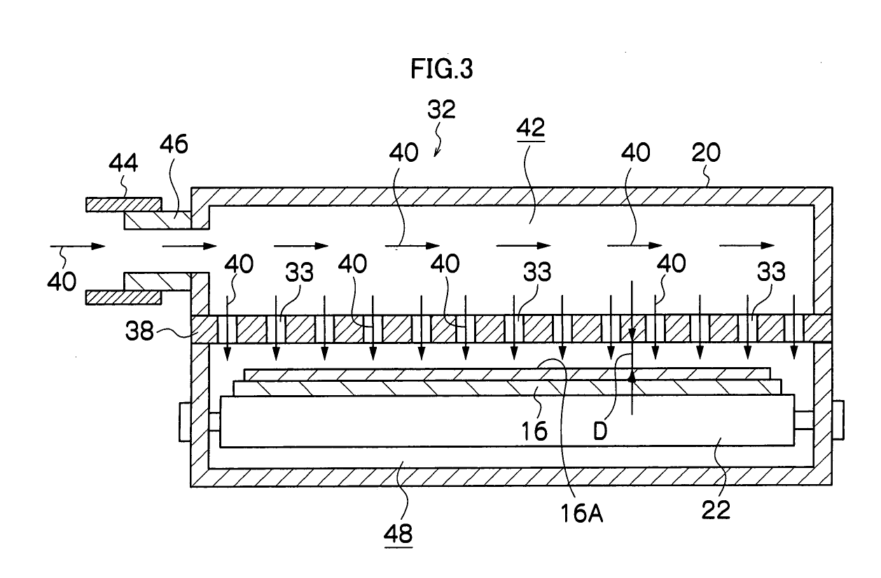

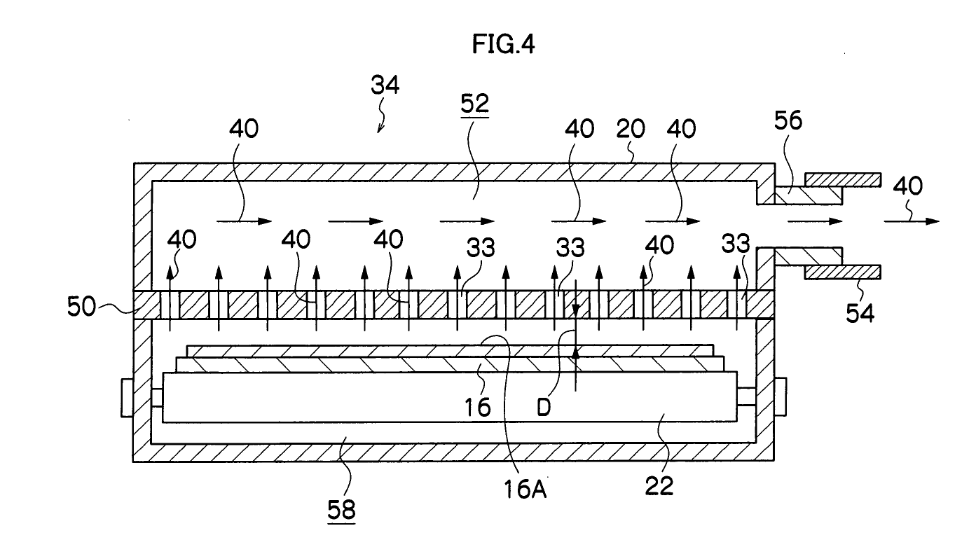

FIG. 1 is a cross sectional view showing a dry case, and FIGS. 2A and 2B are conceptual views diagrammatically showing a blowing and suction unit. FIG. 3 is a cross sectional view showing a blowing device, and FIG. 4 is a cross sectional view showing a suction device.

As shown in FIG. 1, a drying apparatus 10 includes a dry case 20 in which a plurality of pass rollers 22 are arranged to form a pathway to transport a web 16 thereon, so that when the web 16 is fed into the dry case 20 through a web entrance 24, the web 16 runs with a surface having a coated film 16A (see FIG. 3 and FIG. 4) up to be dried by a blowing and suction unit 28 which will be explained below, and exits through a web exit 26.

The inside of the dry case 20 is divided into a plurality of drying zones 30A, 30B, and 30C (for example, 3 zones in FIG. 1), and a drying condition is set for each of the drying zones 30A, 30B, and 30C, and each of the drying zones 30A, 30B, and 30C is provided with one or more blowing and suction units 28 corresponding to the length of the dry path therein (for example, 2 units in FIG. 1). However, the number of divided drying zones and the number of blowing and suction units 28 provided to one drying zone are not limited to the above examples.

As shown in FIG. 1 and FIG. 2, the blowing and suction unit 28 generally includes a blowing device 32 which is disposed on the upstream side in each drying zones 30A, 30B, and 30C, a suction device 34 which is disposed downstream of the blowing device 32, and a planar member 36 which is interposed between the blowing device 32 and the suction device 34. The positions of the blowing device 32 and the suction device 34 are interchangeable, and the suction device 34 may be disposed upstream of the blowing device 32.

As shown in FIG. 2 and FIG. 3, the blowing device 32 includes an outlet port 32A for blowing dry air 40 toward the coated film surface 16A through a first porous distributor 38 which is provided to the outlet port 32A, and is integrally formed with the dry case 20. That is, the inside of the dry case 20 is partitioned along its generally central line into an upper part and a lower part by the first porous distributor 38 which has a number of through holes 33, and an air blow chamber 42 is formed in the space above the first porous distributor 38. The air blow chamber 42 has a side surface into which a connecting port 46 of air supply piping 44 is formed for supplying the dry air 40 into the air blow chamber 42 from a dry air supply device (not shown) and air volume control device (not shown). Since the first porous distributor 38 is disposed at the front surface of the blowing device 32, the pressure of the dry air 40 supplied into the air blow chamber 42 is increased and equalized in the air blow chamber 42, and then the dry air is blown through the first porous distributor 38, resulting in a uniform blow of the dry air.

A passage chamber 48 is formed in the space below the first porous distributor 38, and is provided with pass rollers 22. The web 16 runs on the pass rollers 22 with the coated film surface 16A facing up toward the first porous distributor 38.

As shown in FIG. 2 and FIG. 4, the suction device 34, being disposed on the coated film surface 16A of the web 16 as with the blowing device 32, includes an inlet port 34A for sucking the dry air 40 which is blown out of the blowing device 32 through a second porous distributor 50 provided to the inlet port 34A, and is formed integrally with the dry case 20.

The suction device 34 has the same structure as that of the blowing device 32 except the air flows in the opposite direction to that of the blowing device 32. That is, the inside of the dry case 20 is partitioned along its generally central line into an upper part and a lower part by the second porous distributor 50 which has a number of through holes 33, and an air suck chamber 52 is formed in the space above the second porous distributor 50. The air suck chamber 52 has a side surface into which a connecting port 56 of an air supply piping 54 is formed for connecting a vacuum pump (not shown) and a suction control device (not shown). Since the second porous distributor 50 is disposed at the front surface of the suction device 34 for suction, the dry air 40, being blown out of the blowing device 32 and flowing over the coated film surface 16A, is uniformly sucked into the air suck chamber 52 through the second porous distributor 50. Needless to say, the dry air 40 sucked into the suction device 34 contains the solvent which is evaporated from coated film surface 16A.

A passage chamber 58 is formed in the space below the second porous distributor 50, and is provided with pass rollers 22. The web runs on the pass rollers 22 with the coated film surface 16A facing up toward the second porous distributor 50.

The first and second porous distributors 38, 50 are plate members having a number of through holes 33 formed generally over the entire surface thereof, and may be preferably a wire mesh or a perforated metal for example. The first and second porous distributors 38, 50 preferably have an aperture ratio of 50% or less, more preferably 20% to 40%. In particular, a wire mesh having a mesh count of 250 to 300 and an aperture ratio of 30% may be preferably used.

As shown in FIG. 2, when the outlet port 32A, to which the first porous distributor 38 is provided, has a length A in the running direction of the web, and the inlet port 34A to which the second porous distributor 50 is provided, has a length B in the running direction of the web, both of the lengths A and B are preferably 3 cm or more, more preferably 5 cm or more, and particularly preferably 10 cm or more. While, the first and second porous distributors 38, 50 have a length in the width direction of the web which may be the same as that of the width of the web, but it is particularly preferred that the length is longer than the width of the web by 50 mm or less.

As shown in FIG. 3 and FIG. 4, the first and second porous distributors 38, 50 are preferably separated from the coated film surface 16A by a distance of 50 mm or less.

Although not shown in FIG. 3 and FIG. 4, a two-layer porous distributors which includes another set of first and second porous distributors 38, 50 on the first and second porous distributors 38, 50 is also preferably used. Alternatively, side plates may be preferably provided at both ends of the first and second porous distributors 38, 50 in the width direction of the web to be hanged from the ends in order to decrease the dry air 40 which flows into the back side of the web after being blown toward the coated film surface 16A.

As shown in FIG. 2, a planar member 36 is interposed between the blowing device 32 and the suction device 34, the planar member 36 having a planar surface 36A which is flush with the first porous distributor 38 and the second porous distributor 50. The planar member 36 has a length C in the running direction of the web which is preferably 5 cm or more, more preferably 30 cm or more, and particularly preferably 50 cm or more. The planar surface 36A of the planar member 36 is preferably smoothed.

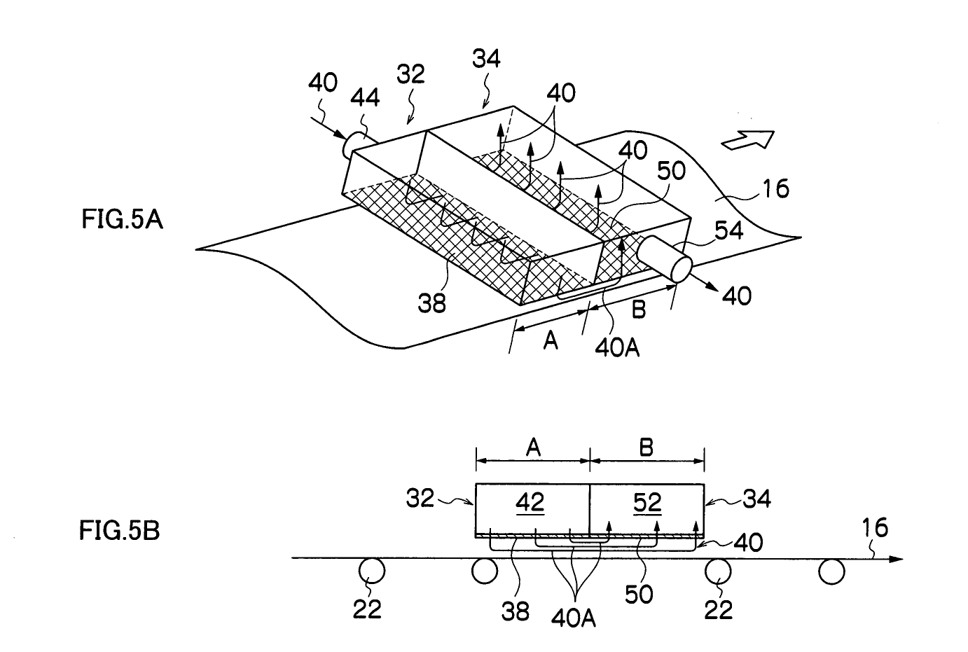

The above embodiment has been described in connection with the most preferable structure having the blowing device 32, the suction device 34, and planar member 36 as the blowing and suction unit 28, but as shown in FIG. 5, the planar member 36 may be omitted. Also, the second porous distributor 50 of the inlet port 34A may be omitted.

### (Optical Compensation Film)

Next, a manufacturing line for an optical compensation film into which the drying apparatus 10 according to the present invention is incorporated will be explained below.

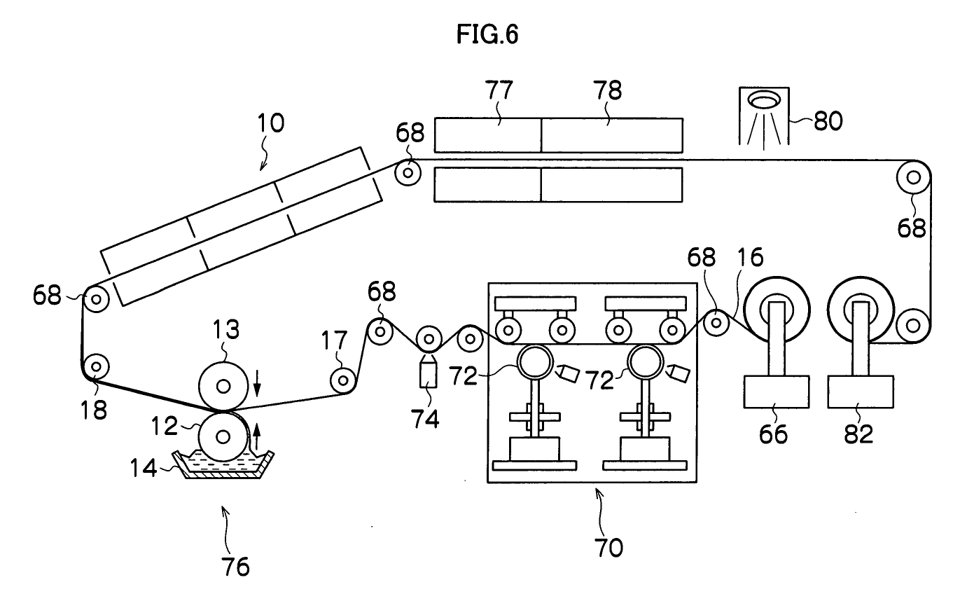

As shown in FIG. 6, the web 16 which is an elongated transparent supporting medium is fed by a feeding device 66, and the web 16 has a transparent resin layer on a surface thereof which has been formed in advance by applying a coating solution containing a resin for forming an alignment film on the surface and drying it. The web 16 is guided by a guide roller 68 to be fed into a rubbing device 70, so that the transparent resin layer is subjected to a rubbing treatment by rubbing rolls 72. This forms an alignment film on the transparent resin layer. In the rubbing device 70, preferably the rubbing rolls 72 are arranged between the two rolls for transportation which are disposed in a serial transportation process of the web 16, and serially provide a rubbing treatment to a surface of the web 16 while the web 16 being wrapped around the rotating the rubbing rolls 72 and being transported. In this case, the rubbing rolls 72 may be disposed with the axes thereof being inclined with respect to the transportation direction of the web 16. Preferably the rubbing rolls 72 have a roundness, a cylindricity, and a deflection each of which are 30 μm or less. An apparatus using the above described rubbing method preferably has one or more extra rubbing rolls therein.

Next, a dust collector 74 removes the dust on the surface of the web 16, and then a gravure coater 76 applies a coating solution which contains a liquid crystalline discotic compound to an alignment film of the web 16. The liquid crystalline discotic compound may be the one which contains a cross linking functional group.

Below the gravure roller 12, there is provided a solution tray 14 which is filled with the coating solution. The gravure roller 12 is immersed in the coating solution at about the lower half thereof. This configuration allows the coating solution to be supplied to the cells on surfaces of the gravure roller 12. An upstream guide roller 17 and a downstream guide roller 18 are supported in parallel to the gravure roller 12. Each of the upstream guide roller 17 and the downstream guide roller 18 is rotatably supported by a bearing member (such as a ball bearing) at the both ends thereof, and preferably does not include a driving mechanism. The gravure coater 76 is desirably mounted in a clean atmosphere such as a clean room. The cleanliness of the atmosphere is preferably of class 1000 or less, more preferably of class 100 or less, and further preferably of class 10 or less.

In FIG. 6, the gravure coater 76 is used as a coater, but other coater may be used. For example, any other method such as dip coating, air knife coating, curtain coating, roller coating, wire bar coating, microgravure coating, extrusion coating, and the like may be used as needed.

Having the coated film 16A formed by the application of the coating solution thereon, the web 16 is dried by the drying apparatus 10 according to the present invention. In this case, preferably the web 16 is introduced in the drying apparatus 10 either within three seconds since the web 16 passes the gravure coater 76 (more precisely, a gravure roller 12) or before the content percentage of the organic solvent in the coating solution drops to less than 50% (more preferably less than 70%) of the original solvent contained in the coating solution at the time of the application, whichever comes first.

Then, the coated film 16A is preferably dried by using the above described blowing and suction unit 28, at least until the point of time when the concentration of the organic solvent in the coated film decreases to 50% or less (half or less) of the value of the organic solvent at the time of the application, or the viscosity of the coated film increases to 10 mPa·s or more, whichever comes first. However, if the blowing and suction unit 28 is arranged too close to the coating position by the coating apparatus 76, since the dry air which flows in from the web entrance of drying apparatus 10 may adversely affect the coating, the blowing and suction unit 28 is preferably arranged downstream of the coating position at least by 10 cm.

The content percentage (residual percentage) of the organic solvent relative to the original solvent contained in the coating solution at the time of the application can be measured as follows. That is, the coated film is scraped by using a “spatula” right before the film is introduced into the drying apparatus 10, and the scraped coated film is immediately put into an airtight glass container, and then the container is covered with a lid to be sealed. The weight of the scraped coated film is obtained (coated film weight 1) by measuring the weight of the airtight glass container and subtracting the appearance weight which was measured in advance. The lid is removed from the airtight glass container to dry the scraped coated film for one hour in an oven which is set at the temperature of 105 degrees Celsius. The weight of the dried coated film is obtained (coated film weight 2) by measuring the weight of the airtight glass container and subtracting the appearance weight. Then, the content percentage (residual percentage) of the organic solvent is calculated by using the coated film weight 1 and the coated film weight 2.

In the drying apparatus 10, a uniform blowing of the dry air 40 is achieved by blowing the dry air 40 through the first porous distributor 38 of the blowing device 32 disposed at an upstream side position of the dry casing 20 toward the coated film surface 16A, so that the area of the coated film surface 16A where the dry air 40 hits is uniformly exposed to the dry air 40. The wind speed of the dry air 40 which is blown toward the coated film surface 16A is preferably within a range of 0.1 to 3 m/sec.

In the present invention, in addition to the uniform blowing of dry air, a uniform suction of the dry air 40 is achieved by sucking the dry air through the second porous distributor 50 of the suction device 34 disposed at a downstream position than the blowing position. Thus, as shown in FIG. 2B, a stream of dry air 40A which is a unidirectional air flow of the dry air 40 flowing in a direction parallel to the running direction of the web over the coated film surface 16A (a flow from the blowing device 32 to the suction device 34 in the same direction as the web running direction) can be formed without turbulence. The term “without turbulence” as used herein means that a stream of dry air 40A flows without forming any turbulence such as eddy current. In this case, it is desirable to control the suction of the dry air by using the suction control device so as to set the linear wind speed of the unidirectional stream of dry air 40A relative to the running web 16 to be within a range of 0.2 to 3 m/sec.

Thus, no more volume of dry air 40 flows along the both ends of the web 16 in the width direction of the web than along the central part of the web 16. And even when the dry case 20 is divided into a plurality of drying zones 30A, 30B, and 30C as shown in FIG. 1, since there is not a flow of the dry air between the adjacent drying zones, no dry air masses 40 collide to each other to form an unrectified flow over the coated film surface 16A. Even when one drying zone is provided with a plurality of the blowing devices 32, no dry air masses 40 collide to each other to form an unrectified flow on the coated film surface 16A. Especially in the present invention, since the planar member 36 having a planar surface 36A which is flush with the first porous distributor 38 and second porous distributor 50 is interposed between the blowing device 32 and the suction device 34 of the blowing and suction unit 28, the planar member 36 provides a narrow flow path for guiding the dry air 40 from the blowing device 32 to the suction device 34 between the planar member 36 and the coated film surface 16A. This facilitates the formation of a unidirectional stream of dry air 40A which flows in a direction parallel to the running direction of the web, and also prevents the formation of turbulence such as eddy current in the stream of dry air 40A.

Therefore, in the field where a highly accurate drying of an optical film and the like is required, a uniform drying can be achieved without causing drying unevenness on the coated film surface 16A.

When the drying of the web 16 in the dryer 10 is completed, the web 16 travels through a downstream drying zone 77, a heating zone 78, and under an ultraviolet lamp 80 in FIG. 6. In this travel, the dried coated layer of the web 16 is heated to form a layer of discotic nematic liquid crystals, and the continuous photoirradiation to the layer cures the discotic liquid crystals. At this point, it is preferable to heat the web 16 at the heating zone 78 by providing hot air or far infrared radiation to the side of the web 16 which does not have the liquid crystal layer or by contacting a heating roller with the side of the web 16 which does not have the liquid crystal layer, or by providing hot air or far infrared radiation both sides of the web 16. After an alignment film and a liquid crystal layer are formed, the web 16 is wound onto a winder 82.

Now, a liquid crystal display, in which an optical compensation sheet having an optically anisotropic layer of a discotic compound formed on the web 16 is directly used in a polarizer as a protective film, will be explained below, but the application of an optical compensation sheet is not limited to this example.

The used discotic compound is described in detail in Japanese Patent Application Laid-Open Nos. 7-267902, 7-281028, and 7-306317. According to these patents, the optically anisotropic layer is formed of a compound which contains discotic structural units. That is, the optically anisotropic layer is a layer of a low molecular weight liquid crystal discotic compound such as monomers, or a layer of polymers which are produced by polymerization (curing) of a polymerizable liquid crystal discotic compound. Examples of such a discotic (disc-like) compound include: benzenes described in the study report by C. Destrade et al., Mol. Cryst. 71, p. 111 (1981); truxenes described in the study report by C. Destrade et al., Mol. Cryst. Volume 122, p. 141 (1985), and Physicslett, A, Volume 78, p. 82 (1990); cyclohexanes described in the study report by B. Kohne et al., Angew. Chem. Volume 96, p. 70 (1984); and aza crown macrocycle or phenylacetylene macrocycle described in the study report by J. M. Lehn et al., J. Chem. Commun., p. 1794 (1985), and the study report by J. Zhang et al., J. Am. Chem. Soc. Volume 116, p. 2655 (1994). The above discotic (disc-like) compounds include those which generally have a structure having the molecules as the central core, and straight chain alkyl groups, alkoxy groups, or substituted benzoyloxy groups as its radially substituted side chain, show liquid crystallinity, and are generally called a discotic liquid crystal. However, discotic (disc-like) compounds are not limited those described above, and include any compound which have negative uniaxiality and can be aligned in a certain direction. Also, the resulting optically anisotropic layer formed of a disc-like compounds, which is disclosed in the above patents, is not always the compound as a final product, and for example includes the low molecular weight discotic liquid crystal which has a group reactive to heat or light and is polymerized or cross-links through a reaction between the group and heat or light that results in a high molecular weight and a loss of liquid crystallinity. Moreover, a compound containing at least one type of disc-like compound which can form discotic nematic phase or uniaxial columnar phase, and also having optical anisotropy is preferably used. Preferably the disc-like compound is triphenylenes. Preferably the triphenylenes is the compound represented by Chemical Formula 2 described in Japanese Patent Application Laid-Open No. 7-306317.

A cellulose acrylate film can be used as a preferred supporting medium (web) of the alignment film. An example of the cellulose acrylate film is described in Japanese Patent Application Laid-Open No. 9-152509 in detail. That is, an alignment film is formed on a cellulose acrylate film or on an undercoating layer which is applied to the cellulose acrylate film. The alignment film functions to define an aligned direction of a liquid crystal discotic compound which is applied onto the alignment film. The term “alignment film” as used herein includes any layer which defines an alignment of an optically anisotropic layer.

Preferable examples of the alignment film include: a rubbed layer of an organic compound (preferably, a polymer); an obliquely deposited layer of an inorganic compound; and a layer having a microgroove; and also include: a built-up film of ω-tricosanoic acid, dioctadecylmethylammonium chloride, methyl stearate, and the like which is formed by using Langmuir-Blodgett technique (LB film), and a layer of derivatives aligned by applying an electric field or a magnetic field.

The organic compounds for an alignment film include: polymers such as polymethylmethacrylate, acrylic acid/methacrylic acid copolymer, styrene/maleinimide copolymer, polyvinyl alcohol, poly(N-methylolacrylamide), styrene/vinyltoluene copolymer, chlorosulfonated polyethylene, cellulose nitrate, polyvinyl chloride, chlorinated polyolefin, polyester, polyimide, vinyl acetate/vinyl chloride copolymer, ethylene/acetic acid vinyl copolymer, carboxymethyl-cellulose, polyethylene, polypropylene, and polycarbonate; and compounds such as silane coupling agent. Preferable polymers include: polyimide, polystyrene, polymers of styrenes, gelatine, polyvinyl alcohol, and alkyl modified polyvinyl alcohol having an alkyl group (preferably, containing 6 or more carbon atoms).

Among those, alkyl modified polyvinyl alcohol is particularly preferred for its property to uniformly align a liquid crystal discotic compound. This is assumed to be due to a strong interaction between an alkyl chain on an alignment film surface and an alkyl side chain of a discotic liquid crystal. The alkyl group preferably includes 6 to 14 carbon atoms, and also preferably is bound to polyvinyl alcohol through —S—, —(CH₃)C(CN)—, or —(C₂H₅)N—CS—S—. The above described alkyl modified polyvinyl alcohol has an alkyl group at its terminal, and preferably has a saponification degree of 80% or more and a polymerization degree of 200 or more. The above described polyvinyl alcohol which has an alkyl group at its side chain may be commercially available, such as MP103, MP203, and R1130 manufactured by Kuraray Co., Ltd.

A polyimide film (preferably, fluorine atom containing polyimide) which is widely used as an alignment film of a liquid crystal display (LCD) can be preferably used as the organic alignment film. This film can be obtained by applying polyamic acid (for example, LQ/LX series manufactured by Hitachi Chemical Co., Ltd. and SE series manufactured by NISSAN CHEMICAL INDUSTRIES, Ltd.) to a surface of a supporting medium, baking the coating at a temperature of 100 to 300 degrees Celsius for 0.5 to 1 hour, and rubbing the coating.

Furthermore, the alignment film which is applied to the cellulose acrylate film is preferably a cured film obtained by incorporating a reactive group into the above described polymer, or by using the above described polymer with a cross-linking agent such as an isocyanate compound and an epoxy compound to cure the polymer.

Preferably, the polymer used in the alignment film and the liquid crystal compound in the optically anisotropic layer are chemically bound to each other through the interfaces of these layers. Preferably, the polymer of the alignment film is formed of polyvinyl alcohol in which at least one hydroxyl group is substituted with a group having a vinyl moiety and an oxilanyl or aziridinyl moiety. The group having a vinyl moiety and an oxilanyl or aziridinyl moiety is preferably bound to a polymer chain of the polyvinyl alcohol derivative through an ether bond, an urethane bond, an acetal bond, or an ester bond. Also, the group having a vinyl moiety and an oxilanyl or aziridinyl moiety preferably does not have an aromatic ring. The above described polyvinyl alcohol is preferably the chemical substance described in Japanese Patent Application Laid-Open No. 9-152509 as Chemical 22.

The rubbing treatment may be the one which is widely employed as a liquid crystal molecular alignment treatment process of LCD. That is, the method for aligning a surface of an alignment film by rubbing the surface in a certain direction with paper, gauze, felt, rubber, or nylon or polyester fiber can be used. Generally, the rubbing treatment is conducted by rubbing a surface several times with a fabric which has fibers of a uniform length and size uniformly implanted therein.

Evaporation materials for forming an obliquely deposited inorganic film include, first of all, SiO, and metal oxides such as TiO₂ and ZnO₂, fluorides such as MgF₂, and metals such as Au and Al. The metal oxides are not limited to the above, and any metal oxide which has a high dielectric constant can be used as an evaporation material. An obliquely deposited inorganic film can be formed by using a deposition apparatus. Such an obliquely deposited inorganic film can be formed by a deposition with a web (supporting medium) being fixed, or by serial depositions with an elongated web being moved. The methods for aligning an optically anisotropic layer without using an alignment film include an application of an electric field or a magnetic field by heating an optically anisotropic layer on a supporting medium to a temperature which allows a discotic liquid crystal layer to be formed.

The cellulose acrylate film can be used in an optical compensation sheet which has the following basic structure as described in detail in Japanese Patent Application Laid-Open Nos. 8-5837, 7-191217, 8-50206, and 7-281028. The cellulose acrylate film can be applied to an optical compensation sheet which is constituted by a cellulose acrylate film and an optically anisotropic layer that is formed on the cellulose acrylate film, for example, and the optically anisotropic layer is formed of a compound which contains a discotic structural unit. The cellulose acrylate film can be preferably applied to an LCD by applying the optical compensation sheet to one side of a polarizer via an adhesive, or by applying the optical compensation sheet to one side of a polarizing element via an adhesive as a protective film. Preferably the optically anisotropic element has a discotic structural unit (preferably, discotic liquid crystal) at least.

Preferably, the discotic structural unit has a disc-shaped surface (hereinafter, also simply referred to as “surface”) which is slanted with respect to a surface of a cellulose acrylate film, and also the angle which is formed between the disc-shaped surface of the discotic structural unit and the cellulose acrylate film varies in the depth direction of the optically anisotropic layer.

The above described optical compensation sheet which is used with a cellulose acrylate film includes preferred aspects as follows:

(a1) The optical compensation sheet, wherein an average of the angle increases in the depth direction of the optically anisotropic layer in proportion to the distance from the bottom surface of the optically anisotropic layer.
(a2) The optical compensation sheet, wherein the angle varies within a range of 5 to 85 degree.
(a3) The optical compensation sheet, wherein the minimum value of the angle is within a range of 0 to 85 degree (preferably, 0 to 40 degree), and the maximum value of the angle is within a range of 5 to 90 degree (preferably, 50 to 85 degree).
(a4) The optical compensation sheet, wherein the difference between the minimum value and the maximum value of the angle is within a range of 5 to 70 degree (preferably, 10 to 60 degree).
(a5) The optical compensation sheet, wherein the angle continuously varies (preferably, increases) in the depth direction of the optically anisotropic layer in proportion to the distance from the bottom surface of the optically anisotropic layer.
(a6) The optical compensation sheet, wherein the optically anisotropic layer further contains cellulose acrylate.
(a7) The optical compensation sheet, wherein the optically anisotropic layer further contains cellulose acetate butyrate.
(a8) The optical compensation sheet, wherein an alignment film (preferably, a cured polymer film) is formed between the optically anisotropic layer and the transparent supporting medium.
(a9) The optical compensation sheet, wherein an undercoating layer is formed between the optically anisotropic layer and the alignment film.
(a10) The optical compensation sheet, wherein the optically anisotropic layer has an absolute minimum value of retardation other than 0 in the direction which is inclined from the normal direction of the optical compensation sheet.
(a11) The optical compensation sheet according to (a8), wherein the alignment film is a rubbed polymer layer.

The optically anisotropic layer preferably contains an organic compound which can change an alignment temperature of the optically anisotropic layer when the compound is added into the optically anisotropic layer. The organic compound is preferably a monomer which has a polymerizable group.

The resulting optical compensation film is advantageously used in a liquid crystal display, particularly in a transmissive liquid crystal display. A transmissive liquid crystal display includes a liquid crystal cell and two polarizers which are disposed on both sides of the liquid crystal cell. The liquid crystal cell carries a liquid crystal between two electrode substrates. In the transmissive liquid crystal display, an optical compensation sheet is interposed between the liquid crystal cell and one of the polarizers, or the liquid crystal cell and both of the polarizers. The liquid crystal cell is preferably a VA mode liquid crystal cell, a TN mode liquid crystal cell, or an OCB mode liquid crystal cell.

### (Anti-Glare Film and Anti-Reflection Film)

Next, a manufacturing line of an anti-glare film and anti-reflection film, into which the drying apparatus 10 according to the present invention, is incorporated will be explained below.

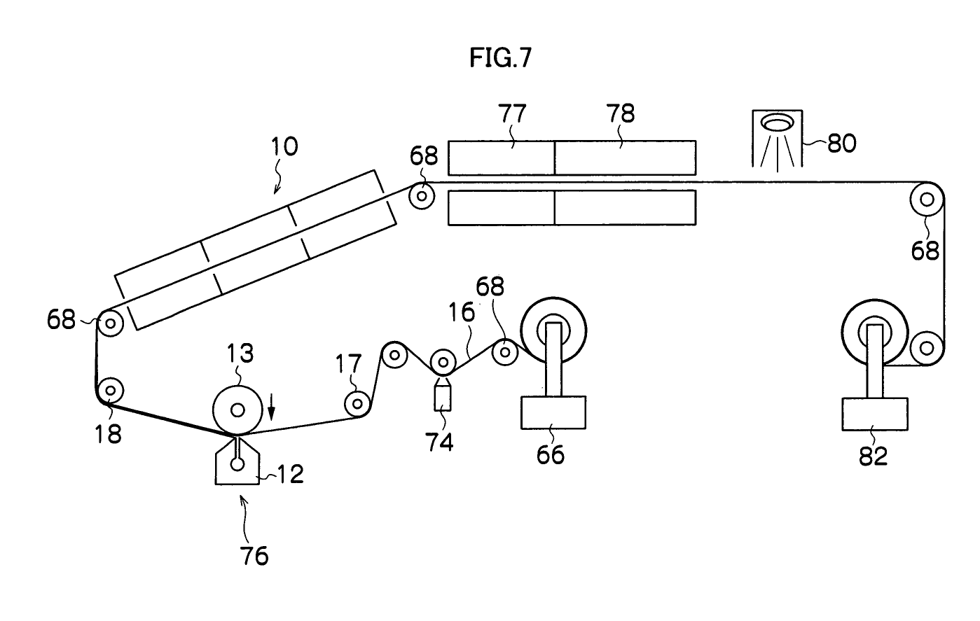

As shown in FIG. 7, this manufacturing line has a structure which is basically similar to that of the manufacturing line of an optical compensation film shown in FIG. 6 except a rubbing device 70 is eliminated, and the same devices of this manufacturing line are designated with the same reference numerals as in FIG. 6.

The feeding device 66 feeds the web 16 which is a transparent supporting medium. The web 16 is guided by a guide roller 68 to be fed into a dust collector 74. The dust collector 74 removes the dust on a surface of the web 16. A coating head 12 of an extrusion type coating apparatus 76 is provided as a coating device downstream of the dust collector 74, and a coating solution is discharged from the coating head 12 to be applied to the web 16 which is wound around a backup roller 13. The coating method is not limited to the extrusion type, and other method such as dip coating, air knife coating, curtain coating, slide coating, roller coating, wire bar coating, gravure coating, and microgravure coating may be used as needed. The coating head 12 is desirably disposed in a clean atmosphere such as a cleanroom. The cleanliness of the atmosphere is preferably of class 1000 or less, more preferably of class 100 or less, and further preferably of class 10 or less.

The coating apparatus 76 serially or simultaneously applies an anti-glare layer and an anti-reflection layer onto the web 16 (including the web which already has some functional layer). Downstream of the coating head 12 is provided the drying apparatus 10 according to the present invention.

In the drying apparatus 10, the formed layer of a coating solution is dried by using the drying method of the present invention as in the case of the above described optical compensation film to evaporate most of the solvent in the coating solution. Preferably a downstream drying apparatus 77 is used to further dry the layer after the drying apparatus 10 is used. Downstream of the downstream drying apparatus 77 is provided an ultraviolet lamp 80 for example for curing the coated film, so that a desirable curing or cross linking can be achieved by ultraviolet irradiation. Depending on the material contained in the coating solution, a heating zone for curing by heat may be provided to achieve a desirable curing or cross linking. Alternatively, after being wound, the web 16 may be subjected to an oven heating or a heating while being transported in a separate process.

A winder 82 is provided downstream of the ultraviolet lamp 80 for winding the web 16 which has an anti-reflection film formed thereon. When a serial coating is performed to form two or more coating layers on the web 16, it is preferable to serially perform the coatings (that is, a coating step and a drying step are repeated without winding the web, and a winding step is finally performed) in terms of productivity.

In this way, in order to improve the visibility of a flat panel display such as LCD, PDP, CRT, and EL, one of or both of an anti-glare layer and an anti-reflection layer is formed on one of or both of the surfaces of the web 16. The web 16 having one of the functions is called an anti-glare film or an anti-reflection film, and the web 16 having both of the functions is called an anti-glare and anti-reflection film. Typically, an anti-glare film is constituted by the web 16 which is a transparent supporting medium and an anti-glare layer, and an anti-reflection film is provided with an anti-reflection layer which is constituted by a single or multiple light interference layers as the outermost surface of the web 16 which is a transparent supporting medium, and also a hard coat layer and an anti-glare layer are interposed between the supporting medium and the light interference layer(s) as needed.

The web 16 is preferably a cellulose acrylate film, and the web 16 of a cellulose acetate film is particularly preferably for an LCD application. When an anti-glare and anti-reflection film of the present invention is used in an LCD, the film is arranged on an outermost surface of a display or at an interface between the air in an inner side of the display, by using an adhesive layer formed on a surface of the film, for example. Since cellulose triacetate is used in a protective film which protects the polarizing devices of a polarizer, it is preferable to use an anti-glare and anti-reflection film of the present invention as the protective film in terms of cost and lower profile of the display.

Now, a preferable anti-glare and anti-reflection film, and preferable aspects of its applications will be explained below.

(b1) An anti-glare and anti-reflection film, having a cellulose acrylate film and at least one low refractive index layer which is formed of a fluorine-containing reign having a refractive index of 1.30 to 1.49, preferably has an anti-glare layer which contains a binder having a refractive index of 1.50 to 2.00 and is interposed between the cellulose acrylate film and the low refractive index layer.

(b1-2) An anti-glare and anti-reflection film, having a cellulose acrylate film and at least one low refractive index layer which is formed of a fluorine-containing reign having a refractive index of 1.30 to 1.49, preferably has a hard coat layer which contains a binder having a refractive index of 1.50 to 2.00 and is interposed between the cellulose acrylate film and the low refractive index layer.

(b2) The anti-glare and anti-reflection film according to (b1), wherein at least one hard coat is preferably interposed between the cellulose acrylate film and the anti-glare layer.

(b3) The anti-glare and anti-reflection film described in any one of (b1), (b1-2) or (b2) or the transparent-type anti-reflection film, wherein the low refractive index layer formed of the fluorine-containing resin is preferably curable by heat or ionizing radiation.

(b4) The anti-glare and anti-reflection film according to (b3), wherein the anti-glare layer is preferably formed of matte fine particles and a binder containing a resin which is curable by ionizing radiation.

(b4-1) The anti-reflection film according to (b1-2), wherein the hard coat layer is preferably formed of a binder containing a resin which is curable by ionizing radiation.

(b5) The anti-glare and anti-reflection film according to (b4), wherein a refractive index difference between the matte fine particles and the binder containing a resin which is curable by ionizing radiation included in the anti-glare layer is preferably less than 0.05.

(b6) The anti-glare and anti-reflection film according to (b4), wherein the matte fine particles contained in the anti-glare layer preferably has a mean particle diameter of 1 μm to 10 μm.

(b7) The anti-glare and anti-reflection film according to (b4), wherein the anti-glare layer preferably contains a binder having a refractive index of 1.50 to 2.00 which is a cured product obtained by heat or ionizing radiation of a mixture of a high refractive index monomer and a (meth)acrylate monomer having a 3 or more functional group.

(b8) The anti-glare and anti-reflection film according to (b4), wherein the anti-glare layer preferably contains a binder having a refractive index of 1.50 to 2.00 which is a cured product obtained by heat or ionizing radiation of a mixture of ultrafine particles of a metal oxide, the metal of which is selected from the group of Al, Zr, Zn, Ti, In, and Sn, and a (meth)acrylate monomer having a 3 or more functional group.

(b9) The anti-glare and anti-reflection film according to any one of (b4) to (b8), wherein the low refractive index layer formed of a fluorine-containing resin preferably has a coefficient of dynamic friction of 0.03 to 0.15 and a contact angle of 90 to 120 degree for water.

(b10) Preferably, the anti-glare and anti-reflection film according to any one of (b1) to (b9) is used as one of the two protective films of a polarization layer in a polarizer.

(b11) Preferably, the anti-glare and anti-reflection film according to any one of (b1) to (b9) or the anti-reflection layer of the anti-glare and anti-reflection polarizer according to (b10) is used as an outermost layer of a display.

(b02) An anti-reflection film includes a high refractive index layer having a refractive index of 1.65 to 2.40 and a low refractive index layer having a refractive index of 1.20 to 1.55, the high refractive index layer preferably containing inorganic fine particles of 5 to 65% by volume which has a mean particle diameter of 1 to 200 nm, and a polymer of 35 to 95% by volume which has a cross-linked anionic group.

(b12-1) An anti-reflection film preferably is a lamination of a high refractive index layer having a refractive index of 1.65 to 2.40, a middle refractive index layer having a refractive index of 1.4 to 1.7, and a low refractive index layer having a refractive index of 1.2 to 1.55 in order. In laminating the layers, the middle refractive index layer is controlled to have a refractive index which is between of a high refractive index and a low refractive index.

(b13) The anti-reflection film according to (b12), wherein the high refractive index layer preferably contains a polymer having an anionic group which is a phosphate group or a sulfonic group.

(b14) The anti-reflection film according to (b12), wherein the high refractive index layer preferably contains a polymer having an anionic group which further has an amino group or an ammonium group.

(b15) The anti-reflection film according to (b12), wherein the high refractive index layer preferably contains inorganic fine particles having a refractive index of 1.80 to 2.80.

(b16) The anti-reflection film according to (b12), wherein preferably the high refractive index layer is formed by coating, and the polymer having an anionic group is formed through a polymerization reaction at the time of or after the coating of the high refractive index layer.

(b117) The anti-reflection film according to (b12), wherein preferably the low refractive index layer is formed of a fluorine-containing resin and is curable by heat or ionizing radiation.

(b18) The anti-reflection film according to (b12), wherein preferably the low refractive index layer contains inorganic fine particles of 50 to 95% by volume having a mean particle diameter of 0.5 to 200 nm, and a polymer of 5 to 50% by volume, and a microvoid is formed between the inorganic fine particles by piling up at least two or more inorganic fine particles in the low refractive index layer.

(b19) Preferably, an anti-glare and anti-reflection film has a surface of the anti-reflection film according to any one of (b12) to (b 18) having a concavo-convex profile, and includes a low refractive index layer and a high refractive index layer which have a substantially uniform film thickness.

(b20) The anti-glare and anti-reflection film according to (b19) is preferably manufactured by performing the steps of: forming at least one layer having a refractive index which is less than that of a transparent supporting medium, on the transparent supporting medium; and forming a concavo-convex profile on at least one surface of the transparent supporting medium by applying an exterior pressure, in this order.

(b21) A polarizer preferably includes the anti-reflection film according to any one of (b12) to (b20) on one or both of the surfaces thereof as a protective film or a film to be attached to a protective film.

(b22) An image display apparatus preferably includes the polarizer according to (b21) with a low refractive index layer, which is arranged outermost on at least one of the surfaces of the polarizer, being mounted on the side to be viewed.

The anti-glare and anti-reflection film may be provided with a hard coat layer as needed. The compound used to form the hard coat layer is preferably a polymer which has a main chain of saturated hydrocarbon or polyether, and preferably has a cross linked structure. In order to obtain a polymer having a cross linked structure, a monomer having two or more ethylenically unsaturated groups is preferably cross linked by heat or ionizing radiation.

The monomers having two or more ethylenically unsaturated groups include: esters of polyhydric alcohol and (meth)acrylic acid (e.g. ethyleneglycol di(meth)acrylate, 1,4-diclohexane diacrylate, pentaerythritol tetra(meth)acrylate), pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, 1,2,3-cyclohexane tetra methacrylate, polyurethane polyacrylate, polyester polyacrylate); vinylbenzene and its derivatives (e.g. 1,4-divinylbenzene, 4-vinylbenzoic acid-2-acryloylethylester, 1,4-divinylcyclohexanone); vinylsulfone (e.g. divinylsulfone); acrylamide (e.g. methylene bisacrylamide) and methacrylamid.

The polymer having a main chain of polyether is preferably synthesized through a ring-opening polymerization reaction of a multifunctional epoxy compound. These monomers having ethylenically unsaturated groups should be cured by an ionizing radiation or a thermal polymerization reaction after coating.

In stead of or in addition to the monomer having two or more ethylenically unsaturated groups, a crosslinked structure may be introduced into the binder polymer by a reaction of a crosslinking group. Examples of the cross linking functional group include an isocyanate group, an epoxy group, an aziridine groups, an oxazoline groups, an aldehyde group, a carbonyl group, a hydrazine group, a carboxyl group, a methylol group, and an active methylene group. Vinylsulfonic acid, acid anhydride, cyanoacrylate derivatives, melamine, etherified methylol, esters, and urethane metal alkoxides such as tetramethoxysilane also can be used to introduce a cross-linked structure. The functional groups which exhibit cross-linking properties as a result of a decomposition reaction, such as a blocked isocyanate group, also can be used. Further, the term “a cross linking group” as used in the present invention is not limited to the above compounds, but can be a group which exhibits a reactivity as a result of a decomposition reaction of the above functional group. These compounds which have a cross linking group should be cross linked, after being applied, by using heat or the like.

Various approaches for providing an anti-glare property to a film are disclosed in patent publications, including: a method for forming an anti-glare layer having a convex-concave surface by dispersing matte particles which have a particle diameter for scattering visible light into a binder; a method for forming convex-concave profile onto a surface of a supporting medium by embossing or sand blasting; and a method for forming convex-concave profile onto a surface by using a phase-separated structure of a coating composition, but typically a method for dispersing matte particles into a binder is practically used.

In forming an anti-glare layer, in order to provide an anti-glare property by forming a convex-concave surface, fine particles (matting agent) of a resin or an inorganic compound are used in addition to a binder of a resin compound. The fine particles preferably have a mean particle diameter of 1.0 to 10.0 μm, more preferably 1.5 to 5.0 μm. Also, the fine particles preferably contains fine particles which have a particle diameter less than a binder film thickness of the anti-glare layer at a ratio of less than 50% in total. The particle size distribution of the fine particles can be measured by using Coulter Counter technique, but is converted into a particle number distribution for examination. The anti-glare layer preferably has a film thickness of 0.5 to 10 μm, more preferably 1 to 5 μm.

The resin binder for forming an anti-glare layer is preferably the material which is used to form the above hard coat layer in terms of film hardness and transparency. When an anti-reflection layer is combined with an anti-glare layer, a monomer having a high refractive index or inorganic fine particles having a high refractive index are used with the above described hard coat material to increase a refractive index of the layer from 1.50 to 2.00, so that an anti-reflection property thereof can be improved. Examples of the high refractive index monomer include: bis(4-methacryloylthiophenyl) sulfide, vinylnaphthalene, vinylphenyl sulfide, 4-methacryloxyphenyl-4′-methoxyphenyl thioether. Examples of the inorganic fine particles having a high refractive index preferably include fine particles, which have a particle diameter of 100 nm or less, preferably 50 nm or less, of at least one oxide selected from the group of titanium, zirconium, aluminum, indium, zinc, tin, and antimony. Examples of the fine particles include TiO₂, ZrO₂, Al₂O₃, In₂O₃, ZnO, SnO₂, Sb₂O₃, and ITO. The inorganic fine particle is preferably added 10 to 90% by weight of the total weight of the hard coat layer, more preferably 20 to 80% by weight.

When a concavo-convex profile is provided to a surface of a supporting medium by embossing, the surface concavo-convex profile is preferably formed after all of the plurality of optical interference layers are formed. If a plurality of optical interference layers are formed by wet coating after a surface concavo-convex profile is formed, a coating solution remains in the concave part of the profile to cause each layer to have an uneven film thickness, resulting in a considerable degrade of its anti-reflection property, which is not preferred. Embossing after the formation of all of the optical interference layers allows the optical interference layers to have a substantially uniform film thickness. The term “substantially uniform” as used herein means that the uniformity is within ±3% of the central film thickness.

The anti-reflection film is configured to have a single layer of a low refractive index layer or multi layers of a low refractive index layer and a high refractive index layer so as to be provided with a film thickness, a refractive index, and a layer structure which are designed based on a principle of light interference which is caused by an optical film. The term “a low refractive index layer” and “a high refractive index layer” as used herein mean a layer having a refractive index which is lower than that of a supporting medium and a layer having a refractive index which is higher than that of a supporting medium respectively, and both of the layers have a film thickness which is equal to or less than the wavelength of a target light of the anti-reflection property. Such a film having an extremely small film thickness is called an optical thin film, and is practically applied to various optically functional layers based on the principle of optical interference such as an anti-reflection film or a reflection film.

The anti-reflection layer preferably includes a low refractive index layer and a high refractive index layer which individually satisfy the following Formulas (f1) and (f2).

mλ/4×0.7<n1d1<mλ/4×1.3 Formula (f1)

nλ/4×0.7<n2d2<nλ/4×1.3 Formula (f2)

where m is a positive odd integer (typically, 1), n is a positive integer, n1 and n2 are refractive indexes of a low refractive index layer and a high refractive index layer respectively, and d1 and d2 are film thicknesses of the low refractive index layer and the high refractive index layer respectively.

A low refractive index layer having a refractive index of 1.30 to 1.49 can be selected as a material which is well balanced in terms of film hardness and refractive index. Specifically, as disclosed in Japanese Patent Application Laid-Open Nos. 11-38202 and 11-326601, a low refractive index layer having air gaps between fine particles which have a too small particle diameter to scatter light, or a fluorine containing compound which is cross linked by heat or ionizing radiation are preferably used. The cross-linking fluorine polymer compound may include a perfluoro alkyl group containing silane compound (for example, (heptadecafluoro-1,1,2,2-tetradecyl) triethoxy silane), and a fluorine-containing copolymer which contains constitutional units of a fluorine-containing monomer and a monomer for providing a cross linking group.

Specific examples of the fluorine-containing monomer unit include: for example, fluoroolefins (e.g. fluoroethylene, vinylidene fluoride, tetrafluoroethylene, hexafluoroethylene, hexafluoropropylene, perfluoro-2,2-dimethyl-1,3-dioxol); partially or completely fluorinated alkyl ester derivatives of (meth)acrylate (for example, Viscoat 6FM (manufactured by OSAKA ORGANIC CHEMICAL Co., Ltd.) and M-2020 (manufactured by DAIKIN INDUSTRIES, Ltd.)); and completely or partially fluorinated vinyl ethers.

Examples of a monomer which is used to add a cross linking group include: (meth) acrylate monomers which contains a cross linking functional group in the molecule in advance like glycidyl methacrylate; and (meth) acrylate monomers having a carboxyl group, a hydroxyl group, an amino group, or a sulfonic group (e.g. (meth) acrylate, methylol (meth) acrylate, hydroxyalkyl (meth) acrylate, and allyl acrylate). The latter can have a cross linked structure after copolymerization, according to the description of Japanese Patent Application Laid-Open Nos. 10-25388 and 10-147739.

Not only the polymers which contain the above fluorine-containing monomer as a constitutional unit, but also copolymers of monomers which do not contain a fluorine atom may be used. The useful monomer unit may include: but not limited to, for example, olefins (ethylene, propylene, isoprene, chloroethylene, vinylidene chloride); acrylic acid esters (e.g. methyl acrylate, ethyl acrylate, 2-ethylhexyl acrylate); methacrylic acid esters (e.g. methyl methacrylate, ethyl methacrylate, butyl methacrylate, ethylene glycol dimethacrylate); styrene derivatives (e.g. styrene, divinylbenzene, vinyltoluene, α-methyl styrene); vinyl ethers (e.g. methyl vinyl ether), vinyl esters (e.g. vinyl acetate, vinyl propionate, vinyl cinnamate); acrylamides (e.g. N-tert butyl acrylamide, N-cyclohexyl acrylamide); methacrylamides; and acrylonitrile derivatives.

Similarly, the high refractive index layer is formed of a material which can be preferably used to increase the refractive index of the above described anti-glare layer. The layer preferably has a refractive index within a range of 1.70 to 2.20, and a film thickness within 5 to 300 nm, and has a refractive index and a film thickness as designed according to the above Formula (f2).

Each of the hard coat layer, the anti-glare layer, and the anti-reflection layer can be formed by a coating method such as dip coating, an air knife coating, curtain coating, roller coating, wire bar coating, gravure coating, microgravure coating, or extrusion coating (U.S. Pat. No. 2,681,294). Two or more layers may be simultaneously coated. Methods for a simultaneous coating are described in U.S. Pat. Nos. 2,761,791, 2,941,898, 3,508,947, 3,526,528, and “Coating Engineerings”, by Yuji Harasaki, p. 253, Asakura Publishing Co., Ltd. (1973).

Japanese Patent Application Laid-Open No. 2003-149413 describes a light diffusion film, which is a cellulose acetate film having a oxidation degree of 59.0 to 61.5%, having a light diffusion layer formed thereon which contains light-transmissive fine particles in a light-transmissive resin, the cellulose acetate film having a thickness of 20 to 70 μm, a cutoff value of 0.8 mm per length of 100 mm, and a mean surface roughness Ra of 0.2 μm or less, in order to provide a liquid crystal display for a high quality display with little defects due to an angular change such as decreased contrast, gradation or black and while reverse and hue change, which can be applied to the present invention.

Before or after the formation of the anti-glare film or the anti-reflection film, the back surface of the supporting medium may be subjected to saponification by using some device, so that the film can be directly adhered to one or both of the surfaces of a polarizer as a protective film in manufacturing the polarizer which is used in various applications such as an LCD.

Particularly when a phase difference film is interposed between polarizers and a cell in which liquid crystal is enclosed for a wide angular field of view of an LCD, the polarizers being mounted on both side of the cell, an anti-glare film or an anti-reflection film can be adhered to one surface of one polarizer which is on the view side as a protective film between the polarizer and the air, and a phase difference film can be adhered to the other surface of the polarizer as a protective film between the polarizer and the cell. Such a polarizer of this configuration can provide properties, such as wide angular field of view and low reflectivity, without increasing its thickness compared to conventional polarizers, and is extremely preferable to high performance LCD applications.

A multi-layer film having a plurality of transparent thin films which are formed of inorganic compounds (such as a metallic oxide) having different refractive indexes may be formed by methods including: chemical vapor deposit (CVD) method; physical vapor deposition (PVD) method; and a sol-gel method using a metal compound such as metal alkoxides in which a film of colloidal metal oxide particles is formed to be subjected to a post treatment (ultraviolet irradiation as in Japanese Patent Application Laid-Open No. 9-157855, or plasma treatment as in Japanese Patent Application Laid-Open No. 2002-327310). Meanwhile, various types of an anti-reflection film which is formed by laminating a plurality of thin films of a matrix dispersion of inorganic particles have been proposed as a highly productive anti-reflection film.

An anti-reflection film, which is formed by one of the above method and has a fine concavo-convex profile thereon to be provided with anti-glare property, is also one example.

### (Layer Structure of Coating-Type Anti-Reflection Film)

An anti-reflection film having at least a middle refractive index layer, a high refractive index layer, and a low refractive index layer (outermost layer) in order on one surface of the web 16 which is a transparent supporting medium is designed to have refractive indexes which satisfy the following relationship. That is, the high refractive index layer has a refractive index larger than that of the middle refractive index layer, and the middle refractive index layer has a refractive index larger than that of the transparent supporting medium, and the transparent supporting medium has a refractive index larger than that of the low refractive index layer, and also a hard coat layer may be interposed between the transparent supporting medium and the middle refractive index layer. Alternatively, the anti-reflection film may be formed of a middle refractive index hard coat layer, a high refractive index layer, and a low refractive index layer. Examples of such a film can be found in Japanese Patent. Application Laid-Open Nos. 8-122504, 8-110401, 10-300902, 2002-243906, and 2000-111706, for example. Also, each layer of such a film may be provided with another property, and examples of such a layer include a low refractive index layer having antifouling property, and a high refractive index layer having antistatic property (see Japanese Patent Application Laid-Open Nos. 10-206603, 2002-243906, for example). The anti-reflection film preferably has a haze of 5% or less, more preferably 3% or less. The anti-reflection film preferably has a hardness of H or more as measured by a pencil hardness test in compliance with JIS K 5400, more preferably 2H or more, and most preferably 3H or more.

An anti-glare and anti-reflection film having an anti-glare layer and a low refractive index layer on one surface of the web 16 is designed to have refractive indexes which satisfy the following relationship. That is, the anti-glare layer has a refractive index larger than that of the low refractive index layer, and also a hard coat layer may be interposed between the transparent supporting medium and the anti-glare layer. The anti-reflection film preferably has a haze which is suitable to the anti-glare layer. The anti-glare and anti-reflection film preferably has a hardness of H or more as measured by a pencil hardness test in compliance with JIS K 5400, more preferably 2H or more, and most preferably 3H or more.

An transparent-type anti-reflection film having a hard coat layer on one surface of the web 16 and a low refractive index layer laminated on the hard coat layer is designed to have refractive indexes which satisfy the following relationship. That is, the hard coat layer has a refractive index larger than that of the low refractive index layer. The anti-reflection film preferably has a haze of 3% or less, more preferably 1% or less. The anti-reflection film preferably has a hardness of H or more as measured by a pencil hardness test in compliance with JIS K 5400, more preferably 2H or more, and most preferably 3H or more.

Alternatively, an anti-glare layer is further formed on the web 16 having a high refractive index layer and a low refractive index layer to obtain an anti-glare and anti-reflection film which is designed to have refractive indexes which satisfy the following relationship. That is, the high refractive index layer has a refractive index larger than that of the transparent supporting medium, and the transparent supporting medium has a refractive index larger than that of the low refractive index layer. The anti-reflection film preferably has a haze which is suitable to the anti-glare layer. The anti-reflection film preferably has a hardness of H or more as measured by a pencil hardness test in compliance with JIS K 5400, more preferably 2H or more, and most preferably 3H or more.

Alternatively, a hard coat layer is further formed on the web 16 having a high refractive index layer and a low refractive index layer to obtain an anti-glare and anti-reflection film which is designed to have refractive indexes which satisfy the following relationship. That is, the high refractive index layer has a refractive index larger than that of the transparent supporting medium, and the transparent supporting medium has a refractive index larger than that of the low refractive index layer. The anti-reflection film preferably has a haze of 5% or less, more preferably 3% or less. The anti-reflection film preferably has a hardness of H or more as measured by a pencil hardness test in compliance with JIS K 5400, more preferably 2H or more, and most preferably 3H or more.

### (Transparent Supporting Medium for Anti-reflection Film)

The web 16 which is a transparent supporting medium preferably has a light transmission of 80% or more, more preferably 86% or more. The transparent supporting medium preferably has a haze of 2.0% or less, more preferably 1.0% or less. The web 16 preferably has a refractive index of 1.4 to 1.7. The web 16 preferably is a plastic film. The material of the plastic film includes cellulose ester, polyamide, polycarbonate, polyester (e.g. polyethylene terephthalate, polyethylene naphthalate), polystyrene, polyolefin, polysulfone, polyether sulfone, polyalylate, polyether imide, polymethyl methacrylate, and polyether.

### (High Refractive Index Layer and Middle Refractive Index Layer)

A layer having a high refractive index in an anti-reflection film is formed of a curable film which at least contains ultrafine particles of a high refractive index inorganic compound having a mean particle diameter of 100 nm or less and a matrix binder. The fine particles of a high refractive index inorganic compound may be an inorganic compound having a refractive index 1.65 or more, preferably 1.7 or more. Examples of the compound include oxides of Ti, Zn, Sb, Sn, Zr, Ce, Ta, La, In, and the like, and complex oxides containing their metal atoms. Such ultrafine particles may be formed by: a treatment of particle surfaces with a surface treatment agent (for example, silane coupling agent as in Japanese Patent Application Laid-Open Nos. 11-295503, 11-153703, 2000-9908, anionic compound, or organic metal coupling agent as in Japanese Patent Application Laid-Open No. 2001-310432); a formation of a core-shell structure with a core of a high refractive index particle (e.g. Japanese Patent Application Laid-Open No. 2001-166104); a use of a certain dispersing agent (e.g. Japanese Patent Application Laid-Open No. 11-153703, and U.S. Pat. No. 6,210,858B1), and the like. Materials for forming a matrix include thermoplastic resins and curable resin coating which are known in the art. As the material, one composition type selected from a multifunctional compound containing composition which contains at least two or more radical polymerizable and/or cationic polymerizable groups, an organic metal compound containing a hydrolyzable group, and its partial condensate composition is preferred. Examples of such a compound can be found in Japanese Patent Application Laid-Open Nos. 2000-47004, 2001-315242, 2001-31871, and 2001-296401, for example. Also, a colloidal metal oxide obtained from a hydrolytic condensation of a metal alkoxide, and a curable film obtained from a metal alkoxide composition are also preferred, which is described in Japanese Patent Application Laid-Open No. 2001-293818, for example. The high refractive index layer typically has a refractive index of 1.70 to 2.20. The high refractive index layer preferably has a thickness of 5 nm to 10 μm, more preferably 10 nm to 1 μm. The middle refractive index layer is controlled to preferably have a refractive index which is between the refractive index of a low refractive index layer and the refractive index of a high refractive index layer. The middle refractive index layer preferably has a refractive index of 1.50 to 1.70.

### (Low Refractive Index Layer)

A low refractive index layer is laminated on a high refractive index layer in serial. The low refractive index layer has a refractive index of 1.20 to 1.55, preferably 1.30 to 1.50. The low refractive index layer is preferably formed as an outermost layer having scratch abrasion resistance and antifouling property. A surface which is provided with sliding property is effective to significantly increase the scratch abrasion resistance, and the sliding property may be provided by a device for forming a thin film with a compound into which is silicone or fluorine introduced, which are known in the art. The fluorine containing compound preferably has a refractive index of 1.35 to 1.50, more preferably 1.36 to 1.47. The fluorine containing compound preferably contains a cross linkable or polymerizable functional group which contains fluorine atoms 35 to 80% by volume. Such a compound can be found in: Japanese Patent Application Laid-Open No. 9-222503, paragraphs [0018] to [0026]; Japanese Patent Application Laid-Open No. 11-38202, paragraphs [0019] to [0030]; Japanese Patent Application Laid-Open No. 2001-40284, paragraphs [0027] to [0028]; and Japanese Patent Application Laid-Open No. 2000-284102. The silicone containing compound preferably has a polysiloxane structure, and provides a cross linked structure to the film by containing curable functional groups or polymerizable functional groups in a polymer chain. The compound includes, for example, reactive silicone (for example, SILAPLANE manufactured by Chisso Co.), and polysiloxane which contains silanol groups at both terminals thereof (as in Japanese Patent Application Laid-Open No. 11-258403, for example). The cross linking or polymerization reaction of fluorine-containing and/or siloxane polymer having a cross linkable or polymerizable group is preferably performed by irradiating light or heating a coating composition for forming an outermost layer which contains a polymerization initiator, a sensitizing agent, and the like, at the time of a coating of the composition or after a coating of the composition. A sol-gel curable film is also preferred which is cured by a condensation reaction between an organic metal compound and a silane coupling agent containing a specific fluorine-containing hydrocarbon group in the presence of a catalyst. Preferred examples of the compound includes, for example, a polyfluoroalkyl group containing silane compound and its partial hydrolytic condensation (e.g. compounds described in Japanese Patent Application Laid-Open Nos. S58-142958, S58-147483, S58-147484, 9-157582, and 11-10670), and a silyl compound having a polyperfluoroalkylether group which is a fluorine containing long chain group (e.g. compounds described in Japanese Patent Application Laid-Open Nos. 2000-117902, 2001-48590, and 2002-53804).

Other than the above additives, the low refractive index layer may be added with a filler (for example, silicon dioxide (silica), a low refractive index inorganic compound having a primary particle mean diameter of 1 to 150 nm such as a fluorine-containing particle (e.g. magnesium fluoride, calcium fluoride, barium fluoride), an organic fine particle described in Japanese Patent Application Laid-Open No. 11-382, paragraphs [0020] to [0038]), a silane coupling agent, a slip agent, a surfactant, and the like. When the low refractive index layer is provided as an outermost layer, the low refractive index layer may be formed by a vapor phase method (e.g. vacuum deposition, sputtering, ion plating, and plasma-CVD). A coating method is preferred to form such a layer for its low cost in manufacturing. The low refractive index layer preferably has a film thickness of 30 to 200 nm, more preferably 50 to 150 nm, and most preferably 60 to 120 nm.

### (Other Layer in Anti-Reflection Film)

Furthermore, a hard coat layer, a forward scattering layer, a primer layer, an antistatic layer, an undercoat layer, a protective layer, and the like may be provided in an anti-reflection film.

### (Hard Coat Layer)

A hard coat layer is formed on a transparent supporting medium to impart a physical hardness to the anti-reflection film. It is particularly preferred to interpose the hard coat layer between the transparent supporting medium and the high refractive index layer. The hard coat layer is preferably formed by a cross-linking reaction or a polymerization reaction of a photo and/or heat curable compound. The curable functional group is preferably a photopolymerizable functional group, and the hydrolyzable functional group containing organic metal compound is preferably an organic alkoxysilyl compound. The specific preferable compounds include those described above for the high refractive index layer. A specific composition for constituting the hard coat layer includes the one described in Japanese Patent Application Laid-Open Nos. 2002-144913 and 2000-9908, for example.

The high refractive index layer may function as a hard coat layer. In this case, a hard coat layer is preferably formed by incorporating fine particles therein in a finely dispersed state by using an approach described above for a high refractive index layer. The hard coat layer also may function as an anti-glare layer which is provided with an anti-glare function by incorporating particles having a mean particle diameter of 0.2 to 10 μm therein, which will be described below. The hard coat layer may have a film thickness as appropriately designed for applications. The hard coat layer preferably has a film thickness of 0.2 to 10 μm, more preferably 0.5 to 7 μm. The hard coat layer preferably has a hardness of H or more as measured by a pencil hardness test in compliance with JIS K 5400, more preferably 2H or more, and most preferably 3H or more. Also, a hard coat layer as a test piece with less abrasion loss after a taberabration test in compliance with JIS K 5400 is more preferred.

### (Forward Scattering Layer)

A forward scattering layer is formed in the case the resulting anti-reflective film is applied to a liquid crystal display in order to improve its angular field of view characteristic when an angle of view is inclined upward, downward, and to left direction and right directions. The hard coat can function as a forward scattering layer when fine particles having different refractive indexes are dispersed in the above described hard coat layer. Examples of the forward scattering layer can be found in Japanese Patent Application Laid-Open No. 11-38208 in which a forward scattering coefficient is specified, Japanese Patent Application Laid-Open No. 2000-199809 in which a relative refractive index between a transparent resin and fine particles is specified within a certain range, and Japanese Patent Application Laid-Open No. 2002-107512 in which a haze value is defined to be 40% or more.

### (Anti-Glare Function)

The anti-reflection film may be provided with an anti-glare function for scattering an external light. The anti-glare function can be obtained by forming a concavo-convex profile on a surface of the anti-reflection film. When the anti-reflection film has the anti-glare function, the anti-reflection film preferably has a haze of 3 to 30%, more preferably 5 to 20%, most preferably 7 to 20%. The concavo-convex profile may be formed on a surface of the anti-reflection film by any method which keeps the surface profile well. The method includes, for example: a method for forming concavo-convex profile on a film surface by using fine particles in a low refractive index layer (e.g. Japanese Patent Application Laid-Open No. 2000-271878); a method in which a layer underlying a low refractive index layer (a high refractive index layer, a middle refractive index layer, or a hard coat layer) is formed by adding a small amount (0.1 to 50% by volume) of relatively large particles (particle diameter 0.05 to 2 μm) to form a concavo-convex on the surface thereof, and then a low refractive index layer is formed on the layer with the profile being maintained (e.g. Japanese Patent Application Laid-Open Nos. 2000-281410, 2000-95893, 2001-100004, and 2001-281407); and a method in which after an uppermost layer (antifouling property layer) is formed, a concavo-convex profile is physically transferred to a surface of the uppermost layer (e.g. embossing as in Japanese Patent Application Laid-Open Nos. S63-278839, 11-183710, and 2000-275401).

### EXAMPLES

### Example A

In Example A, drying unevenness obtained by using a drying apparatus according to the present invention was compared with that obtained by using a conventional drying apparatus.

An anti-glare and anti-reflection sheet was made by using manufacturing line shown in FIG. 7. As a coating device, a bar coater was used instead of the extrusion-type coating apparatus 76. The bar coater had a wire bar which had a diameter of 10 mm, and a wire which had a size of 75μ and was wound around the shaft.

### (Preparation of Coating Solution for Anti-Glare Layer)

A coating solution for an anti-glare layer was prepared by dissolving a mixture of dipentaerithritol pentaacrylate and dipentaerithritol hexaacrylate (DPHA, Nippon Kayaku Co., Ltd.) 75 g and a coating solution for a hard coat containing a dispersion of zirconia ultrafine particles having a particle diameter of about 30 nm (DeSolite Z-7401, manufactured by JSR Co.) 240 g into a solvent mixture of methyl ethyl ketone/cyclohexanone (54/46% by weight) 52 g. The resulting solution was added with a photoinitiator (IRGACURE 907, manufactured by Ciba Fine Chemicals Co., Ltd.) 10 g, which was stirred until dissolved to be further added with a fluorine surfactant (MEGAFAC F-110PF, manufactured by Dainippon Ink and Chemicals Incorporated) 0.93 g (when the solution was coated and cured with ultraviolet light, the resulting coated film had a refractive index of 1.65). Then, the solution was added with a dispersion 29 g and stirred, and the resulting solution was filtered by a polypropylene filter having a pore size of 30 μm to obtain a coating solution for an anti-glare layer, the dispersion being obtained by dispersing cross-linking polystyrene particles which have a number mean particle diameter of 2.0 μm and a refractive index of 1.61 (SX-200HS, manufactured by Soken Chemical & Engineering Co., Ltd.) 20 g into a solvent mixture of methyl ethyl ketone/cyclohexanone (54/46% by weight) 80 g to be stirred by using a high speed dispersion mixer at 5000 rpm for one hour, and filtering the resulting dispersion by polypropylene filters having pore sizes 10 μm, 3 μm, and 1 μm (PPE-10, PPE-03, and PPE-01 respectively, all manufactured by FUJIFILM Co.).

The coating solution had a viscosity of 7 mPa·s and a surface tension of 0.033 N/m.

### (Web)

The web 16 was a triacetylcellulose film (FUJITAC, manufactured by FUJI PHOTO FILM Co., Ltd.) which was a transparent web having a thickness of 80 μm and a width of 1470 mm.

### (Coating and Drying Process)

The obtained coating solution was applied to a hard coat layer on the web 16 by using a bar coater, while the web 16 was running at a speed of 5 m/min, so that 4 ml of the coating solution was applied to a surface area 1 m² of the web 16 (film thickness 4 μm at the time of coating) to form a coating having a width of 1430 mm.

The hard coat layer is preferably formed through a cross-linking reaction or a polymerization reaction of a photo and/or heat curable compound. The curable functional group is preferably a photopolymerizable functional group, and an organic metal compound which contains hydrolyzable functional groups, particularly an organic alkoxysilyl compound is preferred. Specific compositions for constituting the hard coat layer include those described in Japanese Patent Application Laid-Open Nos. 2002-144913, 2000-9908, and International Patent Publication No. WO00/46617, for example. The hard coat layer preferably has a film thickness of 0.2 to 10 μm, more preferably 0.5 to 7 μm. The hard coat layer preferably has a hardness of H or more, more preferably 2H or more, and most preferably 3H or more as measured by a pencil hardness test in compliance with JIS K 5400. Also, the hard coat layer as a test piece with less abrasion loss after a taber-abration test in compliance with JIS K 5400 is more preferred.

The coated film on the web 16 was dried by using a drying apparatus according to the present invention in Examples 1 to 3 and a conventional drying apparatus in Comparative Examples 1 and 2, and the state of drying unevenness which was present on each coated film surface was visually evaluated by a sensory test. The drying unevenness on the each coated film surface was visually evaluated in the scattered light under a 3-wavelength fluorescent lamp after a coating was made with a felt tip pen on the backside of the transparent web.

Both in Examples and in Comparative Examples, the drying apparatuses had a drying zone which has a longitudinal length of 2 m, and blew dry air from the blowing device at an air flow of 10 m³/min. In Examples, the outlet port 32A and inlet port 34A for blowing dry air had a length of 1500 mm in the width direction of the web.

In Example 1, the blowing device 32 including the outlet port 32A which had a length of 30 cm in the running direction of the web and was provided with a wire mesh of 250 mesh count as the first porous distributor 38, and the suction device 34 including the inlet port 34A which had a length of 20 cm in the running direction of the web and was not provided with a wire mesh were combined as a unit, and four of the units were arranged along a 2 m drying zone. The blowing device 32 and the suction device 34 formed a stream of dry air in the running direction of the web.

Example 2 was performed in the same way as in Example 1 except the inlet port 34A of the suction device 34 was provided with a wire mesh of 250 mesh count as the second porous distributor 50.

In Example 3, the blowing device 32 including the outlet port 32A which had a length of 60 cm in the running direction of the web and was provided with a wire mesh of 250 mesh count as the first porous distributor 38, and the suction device 34 including the inlet port 34A which had a length of 40 cm in the running direction of the web and was provided with a wire mesh of 250 mesh count as the second porous distributor 50 were combined as a unit, and two of the units were arranged along a 2 m drying zone. The blowing device 32 and the suction device 34 formed a stream of dry air in the running direction of the web. The blowing device 32 and the suction device 34 formed a stream of dry air in the running direction of the web.

In Comparative Example 1, seven slit nozzles (without porous distributor) having a width of 10 mm in the running direction of the web and a length of 1500 mm in the width direction of the web were arranged along a 2 m drying zone with a 30 cm space therebetween. An inlet port was provided centrally of the web on the side of the web which was opposite to the coated film surface, to suck and exhaust the dry air blown through the nozzles.

In Comparative Example 2, wire meshes of 250 mesh count were arranged below and close to a coated film formed on a lower surface of a web, all along the drying zone in a horizontal direction, so that the solvent volatiled from the coated film was exhausted through the wire meshes.

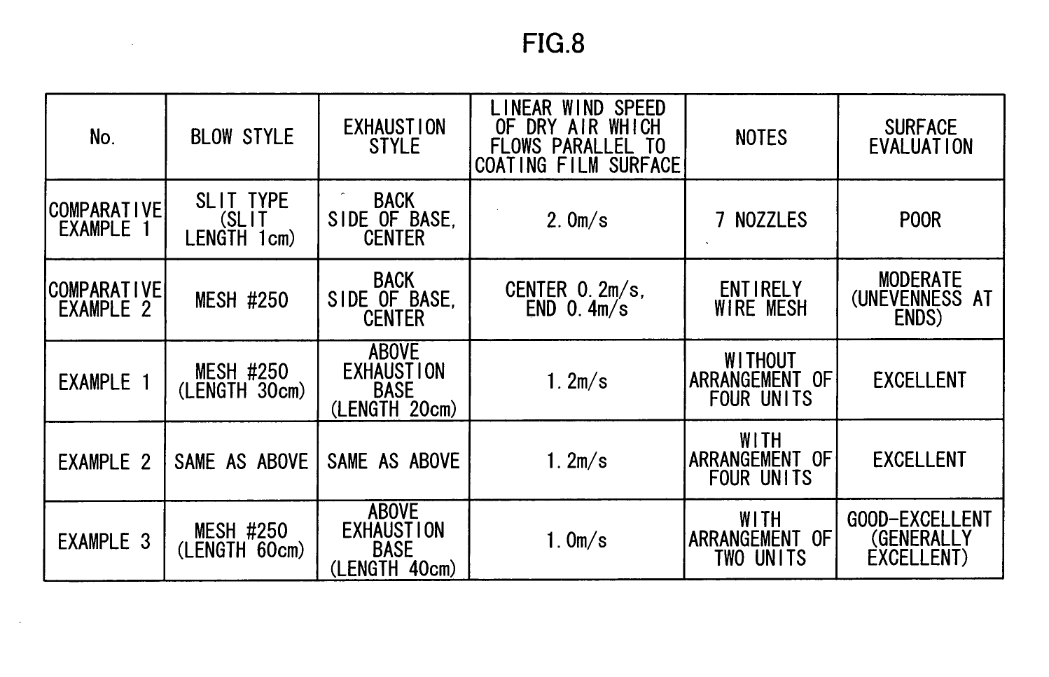

The results of Examples 1 to 3 and Comparative Examples 1 and 2 were shown in FIG. 8. Evaluations were made as follows: Excellent for a coated film surface with no observed drying unevenness; Good for a coated film surface with a little observed drying unevenness; Moderate for a coated film surface with observed drying unevenness; and Poor for a coated film surface with a lot of observed drying unevenness. The linear wind speed of the air flow in the horizontal direction above the coated film surface 16A was measured by using ANEMOMASTER 6114 by KANOMAX.

As a result, Comparative Example 1 was evaluated as Poor due to a lot of drying unevenness observed on the coated film surface. The wind speed above the coated film surface was 2.0 m/sec, and the wind was not flowing in a certain direction, but was radially distributed.

Comparative Example 2 was evaluated as Moderate for its better surface than that in Comparative Example 1, but the wind speed at the both ends of the web was higher than that at the central part in the width direction of the web, resulting in a coating unevenness across the width of the web.

To the contrary, Examples 1 to 3 of the present invention were evaluated as Good to Excellent, and particularly good result was obtained with the four unit arrangement in Examples 1 and 2. Although not shown in FIG. 8, the cases where the stream of dry air flew in the opposite direction to that of the web running direction were also evaluated as Good to Excellent.

### Example B

In Example B, the preferable aspects of examples of the present invention were examined, and a planar member (flat plate) 36 was interposed between the blowing device 32 and the suction device 34 so that the influence of the planar members 36 having different lengths in the running direction of the web onto the drying unevenness of a coated film surface was checked. The length of a drying zone was not particularly limited to 2 m.

In Test 1 to 6, the blowing device 32 including the outlet port 32A which had a length of 30 cm in the running direction of the web and was provided with a wire mesh of 250 mesh count as the first porous distributor 38, and the suction device 34 including the inlet port 34A which had a length of 20 cm in the running direction of the web and was provided with a wire mesh of 250 mesh count as the second porous distributor 50 were combined as a unit, and four of the units were arranged along a drying zone, and in Test 7, six of the units were arranged along a drying zone. The blowing device 32 and the suction device 34 formed a stream of dry air in the running direction of the web.

In Test 1, no planar member (flat plate) 36 was interposed between the blowing device 32 and the suction device 34, and the coating speed was 10 m/min.

In Test 2, the flat plate 36 had a length of 5 cm in the web running direction, and the coating speed was 10 m/min.

In Test 3, the flat plate 36 had a length of 30 cm in the web running direction, and the coating speed was 10 m/min.

In Test 4, the flat plate 36 had a length of 50 cm in the web running direction, and the coating speed was 10 m/min.

In Test 5, the flat plate 36 had a length of 100 cm in the web running direction, and the coating speed was 10 m/min.

In Test 6, the flat plate 36 had a length of 50 cm in the web running direction, and the coating speed was 20 m/min.

In Test 7, the flat plate 36 had a length of 50 cm in the web running direction, and the coating speed was 20 m/min (with six of the units being arranged).

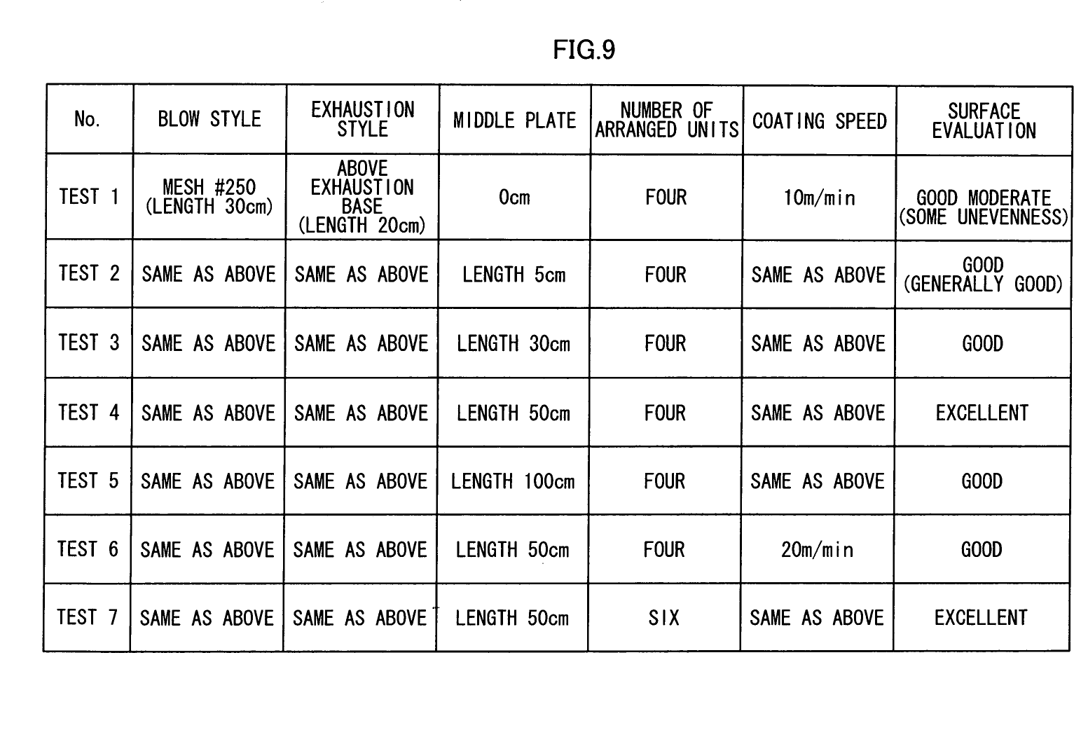

The Test results are shown in FIG. 9.

As seen from Tests 1 to 5 of FIG. 9, although the drying unevenness in the case where the flat plate 36 had a length of 0 cm in the running direction of the web was evaluated as Moderate to Good, the evaluation tuned to be Good with the flat plate 36 having a length of 5 cm, and Excellent with the length of 50 cm. Also, the evaluation tuned to be Good with the length of 100 cm. This shows that the flat plate 36 preferably has a length of 5 cm or more in the web running direction, more preferably around 50 cm. As seen from Test 6 and 7, the increased coating speed of from 10 m/min to 20 m/min lead a good result of Good to Excellent, which shows the drying ability can be also improved by an increased coating speed. In Test 6 and Test 7 with the different number of units, the result in Test 7 with six of the units was better than that of Test 6 with four of the units.

### Example C

In Example C, the preferable aspects of examples of the present invention were examined, and a distance D between the blowing device 32, the suction device 34, and the flat plate 36 and a coated film surface was changed so that the influence of the different distance D onto the drying unevenness of a coated film surface was checked.

In Test 8 to 11, the blowing device 32 including the outlet port 32A which had a length of 30 cm in the running direction of the web and was provided with a wire mesh of 250 mesh count as the first porous distributor 38, the suction device 34 including the inlet port 34A which had a length of 20 cm in the running direction of the web and was provided with a wire mesh of 250 mesh count as the second porous distributor 50, and the flat plate 36 having a length of 50 cm were combined as a unit, and four of the units were arranged along a drying zone. The coating speed was commonly set to be 20 m/min.

In Test 8, the distance D was set to be 50 mm.

In Test 9, the distance D was set to be 30 mm.

In Test 10, the distance D was set to be 70 mm.

In Test 11, the distance D was set to be 100 mm.

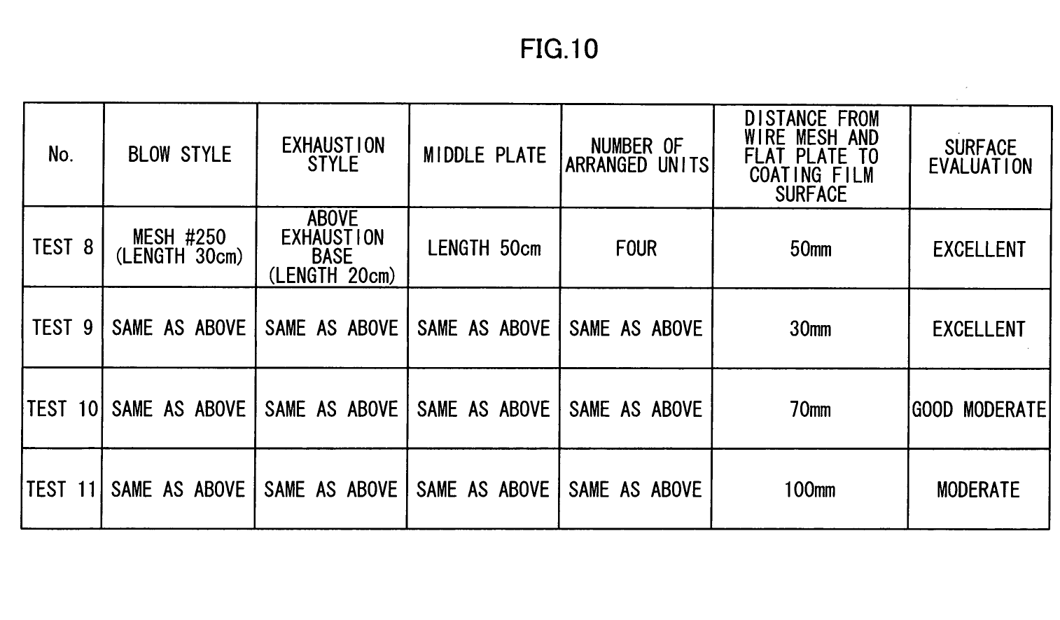

The test results are shown in FIG. 10.

As seen from FIG. 10, in Test 8 where the distance D from the first porous distributor 38 in the outlet port, the second porous distributor 50 in the inlet port 34A, and flat plate 36 to the coated film surface was 50 mm, and in Test 9 where the distance D was 30 mm, the best results of Excellent were obtained, and in the case where the distance D was 70 mm, the result was evaluated as Moderate to Good. This shows the distance D of 50 mm or less is preferred. Also the case where the distance D was 100 mm was evaluated as Moderate, which shows that a too long distance is not preferred.

### Example D

In Example D, the preferable aspects of examples of the present invention were examined, and the length A of the outlet port 32A of the blowing device 32 in the running direction of the web was changed, so that the influence of the different lengths of outlet port 32A on drying unevenness was checked.

In Test 12 to 15, the blowing device 32 including the outlet port 32A (having a different length A) which was provided with a wire mesh of 250 mesh count as the first porous distributor 38, the suction device 34 including the inlet port 34A which had a length of 20 cm in the running direction of the web and was provided with a wire mesh of 250 mesh count as the second porous distributor 50, and the flat plate 36 having a length of 50 cm were combined as a unit, and four of the units were arranged. The distance D from the blowing device 32, the suction device 34, and the flat plate 36 to the coated film surface was commonly set to be 50 mm, and also the coating speed was commonly set to be 20 m/min.

In Test 12, the length A was set to be 30 cm.

In Test 13, the length A was set to be 10 cm.

In Test 14, the length A was set to be 5 cm.

In Test 15, the length A was set to be 3 cm.

In Test 16, the length A was set to be 1 cm.

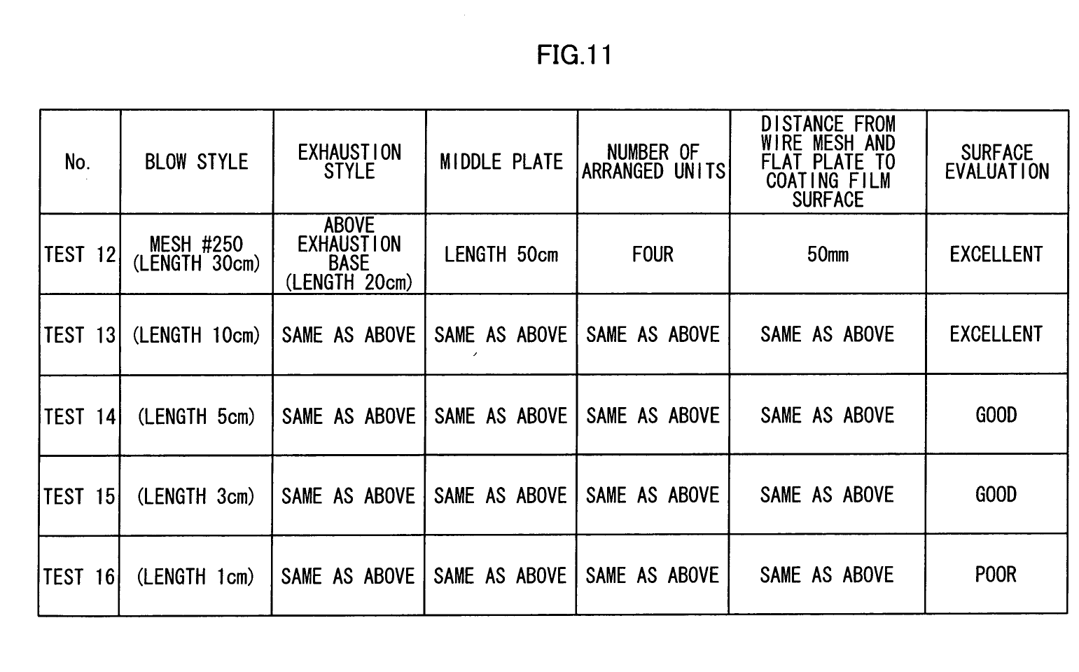

The test results are shown in FIG. 11.

As seen from FIG. 11, the shorter length A of the outlet port 32A in the running direction of the web caused more drying unevenness, and the case with the length A of 3 cm was evaluated as Good, but the case with the decreased length A of 1 cm was evaluated as Poor. This shows that the length A of 3 cm or more of the outlet port 32A in the running direction of the web is preferred. The upper limit of the length A may be conveniently set depending the length of a drying zone or on the number of the blowing device 32, the suction device 34, and flat plate 36 arranged along the drying zone, but in Example 3 of Example A, good results were obtained with the length A up to 60 cm.

Although not shown in FIG. 11, similar to the length A of the outlet port in the blowing device 32, the length B of the inlet port 34A in the suction device 34 in the running direction of the web is preferably 3 cm or more.

### Example E

In Example E, the preferable aspects of examples of the present invention were examined, and a linear wind speed of the stream of dry air from outlet port 32A to the inlet port 34A in a parallel direction to a coated film surface was changed, so that the influence of the different linear wind speeds of the stream of dry air on drying unevenness was checked.

In Tests 17 to 21, the blowing device 32 including the outlet port 32A which had a length of 30 cm the web running direction and was provided with a wire mesh of 250 mesh count as the first porous distributor 38, the suction device 34 including the inlet port 34A which had a length of 20 cm in the running direction of the web and was provided with a wire mesh of 250 mesh count as the second porous distributor 50, and the flat plate 36 having a length of 50 cm were combined as a unit, and four of the units were arranged. The coating speed was commonly set to be 20 m/min.

In Test 17, the linear wind speed was set to be 0.1 m/sec.

In Test 18, the linear wind speed was set to be 0.2 m/sec.

In Test 19, the linear wind speed was set to be 0.8 m/sec.

In Test 20, the linear wind speed was set to be 3.0 m/sec.

In Test 21, the linear wind speed was set to be 4.0 n/sec.

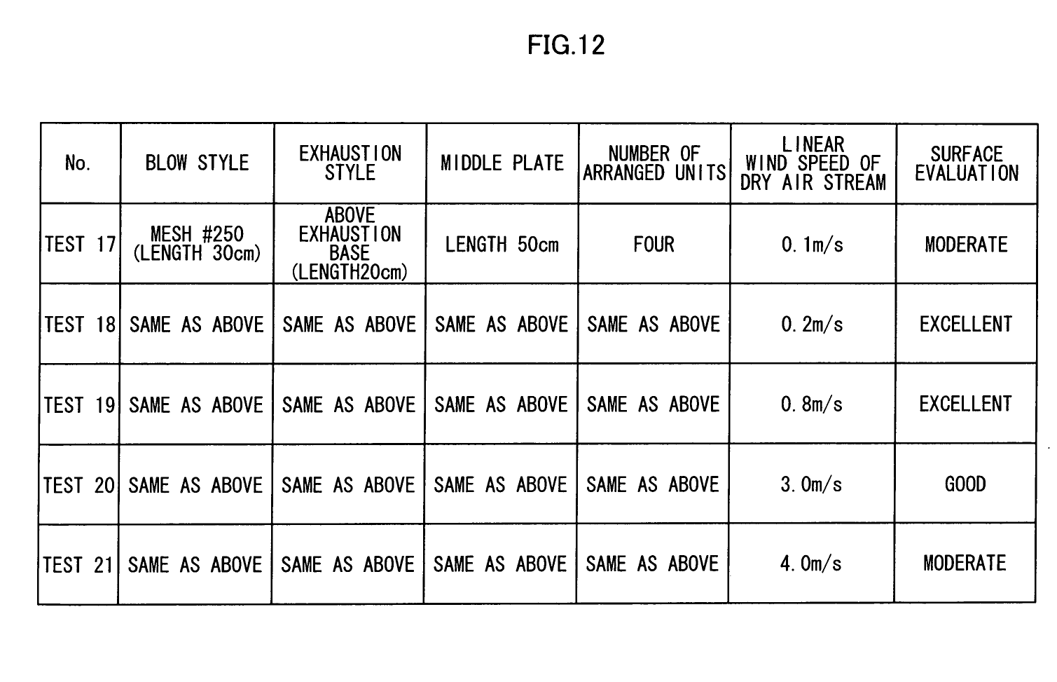

The test results are shown in FIG. 12.

As seen from FIG. 12, in Tests 18 to 20 with the linear wind speed of 0.2 m/sec to 3.0 m/sec, good results were obtained and the evaluations were Good to Excellent. However, in Test 17 with the linear wind speed of less than 0.2 m/sec and in Test 21 with the linear wind speed of more than 3.0 m/sec, the evaluations were Moderate. This shows that the linear wind speed of 0.2 m/sec to 3.0 n/sec is preferred.

What is claimed is:

1. A coated film drying method for drying a film which is coated on a surface of a web while the web is running through a tunnel-shaped dry case having a web entrance and a web exit, comprising the steps of:
blowing dry air toward a surface of the coated film through an outlet port which is provided with a porous distributor; and
sucking the dry air through an inlet port which is disposed at a position downstream or upstream of the position where the dry air is blown out and on the same side as that on which the outlet port is disposed relative to the coated film, so that a stream of the dry air which flows in a direction parallel to the running direction of the web is formed across the entire width of the surface of the coated film.

2. The method for drying a coated film according to claim 1, wherein the inlet port is also provided with a porous distributor.

3. The method for drying a coated film according to claim 1, wherein the outlet port and the inlet port have a length of 3 cm or more in the running direction of the web, and has a length which is generally equal to the width of the web in the width direction of the web.

4. The method for drying a coated film according to claim 1, wherein the dry air is blown toward the surface of the coated film at a wind speed of 0.1 to 3 m/sec.

5. The method for drying a coated film according to claim 1, wherein the linear wind speed of the unidirectional stream of dry air is within a range of 0.2 to 3 m/sec for the running web.

6. The method for drying a coated film according to claim 3, wherein the porous distributor provided to the outlet port and the porous distributor provided to the inlet port are separated from the coated film surface by a distance of 50 mm or less.

7. A coated film drying apparatus for drying a film which is coated on a surface of a web while the web is running through a tunnel-shaped dry case having a web entrance and a web exit, comprising:
a blowing device which includes an outlet port having a length generally equal to the width of the web and blows dry air toward the coated film surface, the outlet port being provided with a porous distributor; and
a suction device which is disposed on the same side as that on which the blowing device is disposed relative to the coated film surface and includes an inlet port having a length generally equal to the width of the web for sucking the dry air blown out of the blowing device therethrough,
the blowing device and the suction device being alternatively arranged along the web running direction in the dry case.

8. The apparatus for drying a coated film according to claim 7, wherein the inlet port is also provided with a porous distributor for sucking dry air therethrough.

9. The apparatus for drying a coated film according to claim 7, wherein the porous distributor is a wire mesh or a perforated metal.

10. The apparatus for drying a coated film according to claim 7, wherein the outlet port and the inlet port have a length of 3 cm or more in the running direction of the web, and has a length which is generally equal to the width of the web in the width direction of the web.

11. The apparatus for drying a coated film according to claim 7, wherein the porous distributor provided to the outlet port and the porous distributor provided to the inlet port are separated from the coated film surface by a distance of 50 mm or less.

12. The apparatus for drying a coated film according to claim 7, wherein a plurality of blowing and suction units each of which includes the blowing device and the suction device are arranged along the direction from the web entrance to the web exit in the dry case in correspondence to the length between the web entrance and the web exit.

13. The apparatus for drying a coated film according to claim 7, wherein a planar member having a planar surface which is flush with the outlet port and the inlet port is interposed between the blowing device and the suction device.

14. The apparatus for drying a coated film according to claim 13, wherein the planar member has a length of 5 cm or more in the running direction of the web.

15. The apparatus for drying a coated film according to claim 7, wherein the dry air is blown out of the outlet port toward the coated film surface at a wind speed of 0.1 to 3 m/sec.

16. The apparatus for drying a coated film according to claim 7, wherein the dry air blown through the outlet port is sucked through the inlet port so that a unidirectional stream of the dry air which flows in a direction parallel to the running direction of the web is formed on the coated film surface, and the linear wind speed of the unidirectional stream is within a range of 0.2 to 3 m/sec.

17. The apparatus for drying a coated film according to claim 7, wherein the outlet port has a length in the width direction of the web which is longer than the web width by 50 mm or less.

18. The apparatus for drying a coated film according to claim 12, wherein the blowing and suction unit is arranged at least until the point of time when the concentration value of a solvent contained in the coated film decreases to 50% or less of the value of the solvent at the application of the coating, or the viscosity of the coated film increases to 10 mPa·s or more, whichever comes first.

19. The apparatus for drying a coated film according to claim 12, wherein the blowing and suction unit is arranged downstream of the coating position of the coated film at least by 10 cm.

20. A method for manufacturing an optical film, comprising the step of using the apparatus for drying a coated film according to claim 7 in a manufacturing line for an optical film.

21. The method for manufacturing an optical film according to claim 20, wherein the optical film is an optical compensation film, an anti-glare film, or an anti-reflection film.
